(19) United States
(12) Patent Application Publication
(10) Pub. No.: US 2007/0274193 A1
(43) Pub. Date: Nov. 29, 2007

(54) Information recording and reproducing apparatus

(76) Inventors: Junichi Akiyama, Kawasaki-Shi (JP); Koichi Kubo, Yokohama-Shi (JP); Junichi Ito, Yokohama-Shi (JP); Kenichi Murooka, Yokohama-Shi (JP); Takahiro Hirai, Yokohama-Shi (JP); Toru Ushirogochi, Yokohama-Shi (JP); Hiroyuki Hieda, Yokohama-Shi (JP)

Correspondence Address: NIXON & VANDERHYE, PC, 901 NORTH GLEBE ROAD, 11TH FLOOR, ARLINGTON, VA, 22203, US

(21) Appl. No.: 11/707,948

(22) Filed: Feb. 20, 2007

(30) Foreign Application Priority Data
Mar. 28, 2006 (JP) 2006-87973

(51) Int. Cl. G11B 9/00

(52) U.S. Cl. 369/126

(57) ABSTRACT

It is made possible to improve a recording density by leaps and bounds. An information recording and reproducing apparatus includes: a control portion including a record-erase circuit which causes electrons to be emitted from the electron emission end to a recording portion on a recording medium by applying a first voltage to the first electrode in a state in which a second voltage is applied to the second electrode at time of information recording or erasing, and a reproducing circuit which causes a reproducing current to flow from the electron emission end to the recording portion on the recording medium by applying a third voltage which is lower than the first voltage to the first electrode in a state in which the second voltage is applied to the second electrode at time of reproducing, the control portion detecting an electric resistance change caused by a change in a recording state in the recording portion.

### CROSS-REFERENCE TO RELATED APPLICATION

This application is based upon and claims the benefit of priority from prior Japanese Patent Application No. 2006-87973 filed on Mar. 28, 2006 in Japan, the entire contents of which are incorporated herein by reference.

### BACKGROUND OF THE INVENTION

1. Field of the Invention

The present invention relates to an information recording and reproducing apparatus in which information is recorded by passing current into a recording medium with an electron beam generated by electric field emission and recorded information is reproduced by irradiating an electron beam to the recording medium to cause a current to flow through a recording portion and reading out a change in resistance value depending upon a difference in recording state in the recording portion as a voltage change.

2. Related Art

Magnetic disks, optical disks and semiconductor memories represented by flash memories are widely used at the present time as conventional information recording storage or memories. In any storage memories, however, it is becoming difficult to increase the capacity and speed from now on. Especially in putting a surface recording density exceeding Tb (terabits)/in² to practical use, serious difficulty is expected if the conventional recording method is used.

In such context, it is demanded to put small-sized, large-capacity, high-speed, inexpensive new storage memories which replace the conventional information recording storage memories to practical use. Nowadays, research and development of a recording and reproducing method based on a new principle are promoted vigorously outside the country or within the country.

Among them, the following principles can be mentioned as a recording and reproducing principle to be noticed. One of the principles is a recording and reproducing principle for PRAMs or RRAMs anticipated to be put to practical use as new solid state memories. In the case of the PRAM (Phase change Random Access Memory), a phase change material (a chalcogen compound such as Ge—Sb—Te, In—Sb—Te, Ag—In—Sb—Te or Ge—Sn—Te) is used. On the other hand, in the case of the RRAM (Resistance Random Access Memory), a CMR (Colossal Magneto Resistive) material (a material having a perovskite crystal structure such as PrCaMnO) is used. For example in the case of the PRAM, recording of information is conducted by letting a current flow through a recording element, heating the recording element to raise its temperature, and thereby causing a phase change (non-crystal=>crystal) in the material. Furthermore, in the PRAM and RRAM, the electrical resistance of the element changes remarkably by three figures to five figures according to whether recording is present. If a predetermined current is caused to flow through the element, therefore, a large voltage is generated according to whether recording is present. As a result, reproduction with high sensitivity is made possible by detecting this voltage change. In addition, the fact that the current value required for recording decreases as the recording element is made small acts favorably in increasing the density.

Another recording and reproducing principle to be noticed is a spin injection magnetic recording method anticipated to be applied to the next generation MRAMs. In this method, recording is conducted by inverting magnetization in a magnetic recording element fast by means of a spin-polarized current. Since the recording current is also reduced by reducing the element size, the method is a recording method which is advantageous to improvement of the recording density. Reproduction is conducted by detecting a resistance change in a TMR element or the like depending upon the direction of the recording magnetization in the magnetic recording element as a voltage change. Recently, it is verified by experiments that a TMR (Tunneling Magneto Resistance) element provides an MR ratio of 140% which is approximately twice as high as that obtained in the conventional art using an alumina film, when a MgO film is used as the magnetic tunnel junction material. Reproduction with a higher sensitivity and a higher speed in the future can be anticipated.

As for any of the above described recording and reproducing principles, development is promoted with an eye to application to future solid state memories. Recently, however, difficulty in density increase in the lithograph technique increases. It is expected to be difficult to obtain a wiring width of 20 nm or less on an extension line of the present technique. Even if the above-described recording and reproducing principle is applied, therefore, it is expected to be difficult to implement a high density solid state memory of a class exceeding 1 Tbpsi and having a wiring width of 20 nm or less, except for a great breakthrough.

On the other hand, recently, MEMS (Micro Electro Mechanical Systems) multi-probe memories are remarked as memories suitable for high density recording and reproducing irrespective of the wiring width. As an example thereof, a memory called “Millipede” and developed by IBM Corporation is known. This is a memory in which topo-recording is thermally conducted on a medium formed of an organic polymer material. (Signal reproduction: a resistance change caused in a cantilever resistor by whether recording is present is detected.) It is supposed that 1,000 cantilevers are disposed on one chip and they are subject to parallel processing simultaneously. Chips of one batch are fabricated. Although in demonstration using a single probe, 1.14 Tbits/in² far exceeding the level in HDDs is already demonstrated in the recording density. Putting this memory to practical use as a future mobile storage is anticipated. In the case where a memory having an SD card size is supposed, however, there is a drawback that the transfer rate is as slow as approximately 1/10 or less as compared with the current HDD. Therefore, it is considered that a faster, higher density MEMS probe memory can be implemented if the recording and reproducing principle (in which fast recording and reproducing are originally possible) as described above is applied from the thermal topo-recording on the polymer material. By the way, it is considered that the MEMS probe memory is suitable for achieving a higher density as compared with the solid state memory, because the recording density in the MEMS probe memory is not subjected to restriction from the wiring width. Furthermore, there is a possibility that a large capacity, ultra-fast disk device having a recording density exceeding 1 Tbpsi can be put to practical use by applying recording and reproducing using a probe to disk devices such as HDDs.

When applying these principles to disk devices and MEMS memories, however, it is necessary to supply a current from a head or probe to a recording medium stably at the time of both recording and reproducing. As a method of supplying this current, the following two kinds are first conceivable. One of the methods is a method of bringing a probe electrode which serves as a current supply element of the head side into ohmic contact with a recording medium. If running is conducted while the probe is in contact with the medium, however, the ohmic contact is very unstable and noise is apt to occur, and consequently application to the memory technique is considered to be unsuitable. The other of the methods is a method of letting a tunnel current flow from the probe electrode to the recording medium. In this method, it is necessary to hold down the distance between the probe and the recording medium to the order of angstrom and always keep this distance in every position on the recording medium. In this method, however, the technical difficulty is very high. Even if the method can be implemented, the quantity of the tunnel current which can be let flow is very small and insufficient for recording and reproducing. Therefore, it must be said that utilization of the tunnel current is also difficult.

On the other hand, the electron beam of “field emission type” is considered to be very promising current supply means. Here, “field emission type” refers to a form in which electrons are emitted directly by providing a high potential gradient (electric field) at a face of the probe electrode from which electrons are emitted. The electron emission region has a feature that it is extremely minute as small as approximately 10 nm or less. Information can be recorded or reproduced by selectively heating the extremely minute region to raise the temperature or selectively letting flow a current to the extremely minute region. The present inventors has already proposed a technique of recording information on a minute recording region of a recording medium by applying an electron beam generated by field emission from the probe electrode toward the recording medium (see, for example, JP-A 2001-250201 (KOKAI)).

If the electron beam generated by field emission is utilized, it is possible to supply a current of a sufficient quantity to the minute region on the medium as described in JP-A 2001-250201 (KOKAI). However, the present inventors confirm that there are problems described hereafter. It is originally ideal that the electron beam generated by field emission is emitted directly under the probe. However, the probe electrode is subjected to electromagnetic disturbance, or influence of the surface roughness of the medium surface or the probe tip. As a result, the irradiation position and irradiation strength of the electron beam become apt to vary, and the tendency becomes remarkable as the irradiation region becomes minute. For applying the field emission electron beam to an MEMS memory or a disk device having an ultra-high density, therefore, advent of a new technique which makes it possible to effectively suppress the variation and apply a stable electron beam is anticipated.

### SUMMARY OF THE INVENTION

An information recording and reproducing apparatus according to a first aspect of the present invention includes: an electrode portion comprising a first electrode having an electron emission end to emit electrons by means of field emission, and a second electrode disposed around the electron emission end of the first electrode to control electrons emitted from the electron emission end; and a control portion including a recording-erasing circuit which causes electrons to be emitted from the electron emission end to a recording portion on a recording medium by applying a first voltage to the first electrode in a state in which a second voltage is applied to the second electrode at time of information recording or erasing, and a reproducing circuit which causes a reproducing current to flow from the electron emission end to the recording portion on the recording medium by applying a third voltage which is lower than the first voltage to the first electrode in a state in which the second voltage is applied to the second electrode at time of reproducing, the control portion detecting an electric resistance change caused by a change in a recording state in the recording portion.

An information recording and reproducing apparatus according to a second aspect of the present invention includes: an electrode portion including a first electrode having an electron emission end to emit electrons by means of field emission, and a second electrode disposed around the electron emission end to control electrons emitted from the electron emission end; a magnetic field applying portion configured to apply a magnetic field to a polarized spin control layer in a recording medium including the polarized spin control layer and a magnetic recording layer; and a control portion including a recording circuit which causes the magnetic field applying portion to apply a magnetic field to the polarized spin control layer to determine a magnetization direction in the polarized spin control layer and causes electrons to be emitted from the electron emission end to make a recording current to flow to the magnetic recording layer via the polarized spin control layer by applying a first voltage to the first electrode in a state in which a second voltage is applied to the second electrode at time of information recording or erasing, and a reproducing circuit which causes the magnetic field applying portion to apply a magnetic field to the polarized spin control layer to set a magnetization direction in the polarized spin control layer and causes a reproducing current to flow from the electron emission end to the magnetic recording layer via the polarized spin control layer by applying a third voltage which is lower than the first voltage to the first electrode in a state in which the second voltage is applied to the second electrode at time of reproducing, the control portion detecting an electric resistance change caused by a change in a recording state in the magnetic recording layer as a voltage change.

An information recording and reproducing apparatus according to a third aspect of the present invention includes: an electrode portion including a first electrode having an electron emission end to emit electrons by means of field emission and which serves as a magnetic pole, and a second electrode disposed around the electron emission end to control electrons emitted from the electron emission end; a magnetic field applying portion configured to apply a magnetic field to the first electrode; and a control portion including a record circuit which causes the magnetic field applying portion to apply a magnetic field to the first electrode to set a magnetization direction in the first electrode and causes spin-polarized electrons to be emitted from the electron emission end to make a recording current to flow to a magnetic recording layer in a recording medium by applying a first voltage to the first electrode in a state in which a second voltage is applied to the second electrode at time of information recording or erasing, and a reproduce circuit which lets a reproducing current flow from the electron emission end to the magnetic recording layer via the polarized spin control layer by applying a third voltage which is lower than the first voltage to the first electrode in a state in which the second voltage is applied to the second electrode at time of reproducing, the control portion detecting an electric resistance change caused by a change in a recording state in the magnetic recording layer being detected by the control portion.

An information recording and reproducing apparatus according to a fourth aspect of the present invention includes: a plurality of electrode portions arranged in a matrix form, each of the electrode portions including a first electrode having an electron emission end to emit electrons by means of field emission, and a second electrode disposed around the electron emission end to control electrons emitted from the electron emission end; and a control portion including a recording-erasing circuit which causes electrons to be emitted from the electron emission end to a recording portion on a recording medium by applying a first voltage to the first electrode in a state in which a second voltage is applied to the second electrode at time of information recording or erasing, and a reproducing circuit which causes a reproducing current to flow from the electron emission end to the recording portion on the recording medium by applying a third voltage which is lower than the first voltage to the first electrode in a state in which the second voltage is applied to the second electrode at time of reproducing, the control portion detecting an electric resistance change caused by a change in a recording state in the recording portion, first electrodes respectively in the electrode portions being operated in parallel to conduct multi-channel recording, erasing or reproducing simultaneously on the recording medium.

An information recording and reproducing apparatus according to a fifth aspect of the present invention includes: a plurality of electrode portions arranged in a matrix form, each of the electrode portions including a first electrode having an electron emission end to emit electrons by means of field emission, and a second electrode disposed around the electron emission end to control electrons emitted from the electron emission end; magnetic field applying portions provided to correspond to the plurality of electrode portions and configured to apply a magnetic field to a polarized spin control layer in a recording medium including the polarized spin control layer and a magnetic recording layer; and a control portion including a record circuit which causes the magnetic field applying portion to apply a magnetic field to the polarized spin control layer to determine a magnetization direction in the polarized spin control layer and causes electrons to be emitted from the electron emission end to make a recording current to flow to the magnetic recording layer via the polarized spin control layer by applying a first voltage to the first electrode in a state in which a second voltage is applied to the second electrode at time of information recording or erasing, and a reproducing circuit which causes the magnetic field applying portion to apply a magnetic field to the polarized spin control layer to set a magnetization direction in the polarized spin control layer and causes a reproducing current to flow from the electron emission end to the magnetic recording layer via the polarized spin control layer by applying a third voltage which is lower than the first voltage to the first electrode in a state in which the second voltage is applied to the second electrode at time of reproducing, the control portion detecting an electric resistance change caused by a change in a recording state in the magnetic recording layer as a voltage change, first electrodes respectively in the electrode portions being operated in parallel to conduct multi-channel recording, erasing or reproducing simultaneously on the recording medium.

### BRIEF DESCRIPTION OF THE DRAWINGS

FIG. 1 is a sectional view showing an information recording and reproducing apparatus according to a first embodiment;

FIG. 2 is a plan view of the information recording and reproducing apparatus according to the first embodiment obtained by seeing it from a recording medium side;

FIG. 3 is a diagram for explaining a shape of a first electrode in the information recording and reproducing apparatus according to the first embodiment;

FIG. 4 is a diagram for explaining a shape of the first electrode in the information recording and reproducing apparatus according to the first embodiment;

FIG. 5 is a view of first and second electrodes in the apparatus according to the first embodiment obtained by seeing them from the recording medium side;

FIG. 6 is a view of first and second electrodes in the apparatus according to the first embodiment obtained by seeing them from the recording medium side;

FIG. 7 is a diagram for explaining an ideal emission state of an electron beam generated by field emission;

FIG. 8 is a diagram for explaining an emission state of an electron beam generated by field emission under disturbance in a conventional apparatus;

FIG. 9 is a diagram for explaining an emission state of an electron beam generated by field emission under disturbance in the apparatus according to the first embodiment;

FIG. 10 is a sectional view showing an information recording and reproducing apparatus according to a second embodiment;

FIG. 11 is a diagram for explaining a recording procedure in the information recording and reproducing apparatus according to the second embodiment;

FIG. 12 is a diagram for explaining a recording procedure in the information recording and reproducing apparatus according to the second embodiment;

FIG. 13 is a diagram for explaining a recording procedure in the information recording and reproducing apparatus according to the second embodiment;

FIG. 14 is a diagram for explaining a recording procedure in the information recording and reproducing apparatus according to the second embodiment;

FIG. 15 is a diagram for explaining a recording procedure in the information recording and reproducing apparatus according to the second embodiment;

FIG. 16 is a diagram for explaining a recording procedure in the information recording and reproducing apparatus according to the second embodiment;

FIG. 17 is a diagram showing an ideal current-magnetization curve of a magnetic recording layer obtained when an external magnetic field is not applied;

FIG. 18 is a diagram showing a current-magnetization curve of the magnetic recording layer obtained when an external magnetic field is applied;

FIG. 19 is a sectional view of the apparatus according to the second embodiment using a magnetic recording medium separated into a plurality of regions over an in-plane direction;

FIG. 20 is a sectional view of the information recording and reproducing apparatus according to the second embodiment;

FIG. 21 is a diagram showing an energy state density of half metal;

FIG. 22 is a sectional view of an information recording and reproducing apparatus according to an example of the second embodiment;

FIG. 23 is a sectional view of an information recording and reproducing apparatus according to a modification of the second embodiment;

FIG. 24 is a sectional view of an information recording and reproducing apparatus according to a third embodiment;

FIGS. 25(a) and 25(b) are diagrams for explaining an information recording and reproducing apparatus according to a fourth embodiment of the present invention;

FIGS. 26(a) and 26(b) are diagrams for explaining an information recording and reproducing apparatus according to a fifth embodiment of the present invention;

FIG. 27 is a circuit diagram showing one concrete example of a recording or erasing circuit in a recording-erasing-reproducing circuit; and

FIG. 28 is a circuit diagram showing one concrete example of a reproducing circuit in the recording-erasing-reproducing circuit.

### DETAILED DESCRIPTION OF THE INVENTION

Hereafter, embodiments of the present invention will be described with reference to the drawings.

Information recording and reproducing apparatuses according to the embodiments described hereafter are field emission type. Prior to description of the embodiments of the present invention, conditions and an electron beam heating mechanism of the field emission type made clear by the present inventors will be first described.

### (Conditions and Electron Beam Heating Mechanism of the Field Emission Type)

Conventionally, it is made common sense that the electron beam is used in vacuum. Considering that the spacing between the probe and the medium is several tens nm or less, the spacing will become further narrower, and the mean free path of electrons under the atmospheric pressure is approximately 150 nm and sufficiently longer than the spacing, it can be said that an emitted electron beam can be applied to the medium without collision if an electron emission source is disposed in close vicinity to the medium. The electron emission source can be mounted on a magnetic recording apparatus placed under the ordinary atmospheric pressure.

The mean free path of electrons depends upon the kind of gas and energy of the electrons. In the case of nitrogen which is one of principal components of the air, the electron energy is approximately 2 eV and the mean free path becomes the shortest. The mean free path of the electrons having the energy of 2 eV in the nitrogen under the atmospheric pressure is 150 nm. In the case of oxygen which is the other principal component of the air, the mean free path becomes the shortest when the electron energy is approximately 20 eV. The mean free path at this time is approximately 300 nm, and it is sufficiently longer than the spacing.

In addition, it can be said that the probability of collision occurring until the electron beam is incident on the medium is further low if a low pressure atmosphere is used. In a form using an inert gas atmosphere, the mean free path of electrons is at least approximately 150 nm in the case of dry nitrogen as described above. If rare gas such as Ne, Ar, Kr or Xe is used, the minimum value of the mean free path of electrons under 1 atm is 1000 nm, 160 nm, 130 nm and 94 nm for respective gases. Any of them is sufficiently longer than the spacing, and there is no change in that electrons can be incident on the medium without scarcely any collisions.

It is desirable for further extending the life of the electron source that the inside of the recording apparatus is provided with an atmosphere of inert gas. If dry nitrogen is used as the inert gas, however, the mean free path of electrons is at least 150 nm as described above. Also in the case where rare gas such as Ne, Ar, Kr or Xe is used, a sufficiently long mean free path is obtained as described above. If the spacing is set equal to several tens nm, then essentially the same operation as that in vacuum is conducted in any case. In this way, stable performance can be obtained by adopting dry nitrogen or a rare gas atmosphere.

As for the pressure in the atmosphere, it may be near the atmospheric pressure, or may be higher or lower than the atmospheric pressure. From the viewpoint of practical use, however, it is convenient to set the pressure in the atmosphere substantially equal to the atmospheric pressure.

Denoting the pressure in the apparatus by P (Torr), the minimum value of the mean free path of electrons in one atmospheric pressure by λmin (nm), and the spacing between the electron emitter and the medium by d (nm), it is basically desirable to satisfy the following expression.

d<λmin×(760/P)

Here, as for the definition of λmin, there are no collisions at a probability of e (where e is the natural logarithm) when electrons run by λmin. In other words, under the condition d<λmin×(760/P), electrons collide with gas molecules with a probability of approximately 63% since the electrons are emitted until the electrons flow into the medium. It is more desirable to satisfy the following expression.

d<(⅓)×λmin×(760/P)

Under this condition, the probability of collision can be made less than ½. It is further desirable to use (⅕) instead of the coefficient (⅓) in the expression. Because the coefficient of this degree brings about a collision probability held down to such a small value as not to interfere with the practical use.

The range of the pressure P is substantially the atmospheric pressure, and it is a range satisfying the condition represented by the expression. And its lower limit can be determined whether a practical apparatus is possible. In the case where the pressure within the apparatus is different from the atmospheric pressure, or in the case where the inside of the apparatus is filled with gas different from the atmosphere even if the pressure within the apparatus is the atmospheric pressure, a hermetically sealed cabinet is needed.

If the hermetically sealed cabinet is used, the mechanical strength of the cabinet determines the lower limit of the pressure P in some cases. In the case of the conventional electron beam recording apparatus in vacuum, a pressure as high as 1 kg/cm² is applied to the cabinet, and consequently it is not easy to make the mechanical strength sufficient and it is not easy to maintain the vacuum state, either.

On the other hand, the lower limit of the pressure P can be determined by weighting allowed practically and the vacuum sealing method. Since this is a design matter of the cabinet, its numerical value cannot be fixed sweepingly. As a practical lower limit value, approximately 0.5 atmospheric pressure can be mentioned. If the pressure is at least approximately 0.5 atmospheric pressure, then the pressure applied to the cabinet is approximately 0.5 kg/cm² and the degree of hermetic sealing may be, for example, approximately the same as the window material of aluminum sash. Thus, the hermetic sealing may be simple.

The upper limit value of the pressure P is basically prescribed by the expression. According to a way of thinking similar to that of the lower limit value, a practical upper limit value is approximately 2 atmospheric pressure. Herein, meaning of “substantially atmospheric pressure” has been described above.

On the other hand, the size of the electron emission region of the field emission electron source depends on the applied electric field and the shape of the emission source. When the electric field is in the range of 10⁶ V/cm to 10⁷ V/cm and selective etching is conducted or a sharp shape having a tip curvature of several tens nano-metre or less is used, the size is approximately 10 nm. It is suitable to apply the electron emission source to future information recording and reproducing apparatuses having a recording cell size of several tens nm. The emission current depends on the applied electric field. In the electric field in the range of 10⁶ V/cm to 10⁷ V/cm, it is possible to obtain an emission current in the range of approximately 10⁻⁶ to 10⁻⁴ A from a region having a diameter of 10 nm.

Here, the emission current is nearly proportional to the square of applied electric field strength according to the Fouler-Nordheim equation. For example, the electric field strength is 3.3×10⁷ V/cm, it is also possible to obtain emission current of 10⁻³ A. The electric field in the range of 10⁶ V/cm to 10⁷ V/cm looks as if it is an extremely high value. Considering that the spacing is several tens nm, however, the value of a voltage to be applied between the electron emission source and the medium is in the range of at most several V to several tens V. Therefore, it is appreciated that the value can be sufficiently applied to the information recording and reproducing apparatus.

A mechanism of medium heating conducted by the electron beam will now be described. When the applied voltage is 10 V (10⁷ V/cm with 10 nm spacing) and the emission current is 10⁻⁴ A, the power becomes 10⁻³ W. When the applied voltage is 33 V (3.3×10⁷ V/cm with 10 nm spacing) and the emission current is 10⁻³ A, the power becomes 3.3×10⁻² W. If this power is thrown into a region of, for example, 10 nm square of the medium, the power density becomes 10⁹ W/cm² or 3.3×10¹⁰ W/cm². If 10 m/s is used as a practical linear velocity (movement velocity of the medium in the track direction) in a disk device such as an HDD, the time required for the medium to pass through the heating region of 10 nm is 1 ns. Therefore, the energy density thrown into the region of 10 nm square of the medium becomes 1 J/cm² or 33 J/cm². Whether this value is sufficient in heating the medium will now be studied.

As a heating mechanism using the electron beam, a mechanism in which the electron beam behaves as a de Broglie wave and heats the medium can be mentioned. The wavelength of the de Broglie wave is approximately 0.4 nm when the electron energy is 10 V, and approximately 0.2 nm when the electron energy is 33 V. Since the wavelength of the de Broglie wave is equivalent to the atom size, lattice vibration (heating) can be caused. Or a mechanism in which the electron beam having such energy is incident on the medium and vibrates and excites plasmons, energy emitted when electron-hole pairs subjected to plasmon oscillation recombine is given to phonons, i.e., lattices, and lattice vibration, i.e., heat is induced is also presumed.

The power density and energy density required for heating can be grasped equivalently to those of optical disks. If the value of the energy density 10⁹ W/cm² or 3.3×10¹⁰ W/cm² or the value of the thrown-in energy density 1 J/cm² or 33 J/cm² is equal to at least the power density or the thrown-in energy density, therefore, it can be said that the medium can be heated sufficiently. For example, in an ordinary phase change disk, the medium can be heated to at least its melting point (600° C.) with a linear velocity of 6 m/s, an FWHM (full width at half maximum) of the optical spot of 0.6 μm, and recording power of 10 mW. Since the time required for the medium to pass through the FWHM of the optical spot is 100 ns and the spot area is 0.28×10⁻⁸ cm², the power density is 3.5×10⁶ W/cm² and the energy density becomes 0.35 J/cm². Therefore, it can be judged that medium heating using plasmon excitation of 1 J/cm² is sufficiently possible. A heating mechanism superposed on plasma oscillation is a mechanism in which the electron beam lets a current flow through the medium and conducts Joule heating. In this case, the Joule heat should be compared with the power density of the optical disk. Heating power obtained when a current of 10⁻⁴ A or 10⁻³ A is let flow through a region of 10 nm square of the medium in the film thickness direction is R×10⁻⁸ W or R×10⁻⁶ W. Here, R is the resistance of the medium. Letting the resistivity of a magnetic film used in a magnetic medium or an magneto-optical recording medium be in the range of 5×10⁻⁶ Ωcm to 6×10⁻⁶ Ωcm, the area of the current path be 10⁻¹² cm² (10 nm square), and the length of the current path, i.e., the thickness of the magnetic film be 2×10⁻⁶ cm (20 nm), R becomes approximately 10 Ω. Therefore, heating power becomes 10⁻⁷ W or 10⁻⁵ W. By dividing the value by the area of heating (10⁻¹² cm²), 10⁵ W/cm² or 10⁷ W/cm² is obtained. Current flow time is different from the irradiation time of the electron beam. When considering by using the Joule heating mechanism, comparison should be conducted by means of not the energy density, but the power density. Therefore, it can be judged that Joule heating is slightly with 10⁻⁴ A and sufficient Joule heating occurs with 10⁻³ A.

As a matter of fact, the process of heating the medium via plasma oscillation excitation and Joule heating caused by current flow coexist. In any process, the power density and the energy density are sufficient as described above. The heating mechanism may be either of them.

In the ordinary information recording and reproducing apparatus (such as a magnetic disk device), the inside atmosphere is the air. When it is attempted to use the electron beam in an atmosphere including oxygen or water, another matter to be considered besides the means free path of electrons is the life of the electron emission source. Under the atmospheric pressure, there is a possibility that air molecules or water molecules in the air will adhere to the electron emission source and impair the life of the electron emission source. In the field emission electron beam source which has been developed vigorously in recent years, endurance against adhering molecules is remarkably high unlike the conventional thermal emission electron beam source and photoelectron emission electron beam source. Especially in the case where carbon (C) is used as the electron emission source, the influence of oxygen is slight. In ensuring the practical life, however, it is necessary to hold down the densities of a gas environment near the emitter, especially oxygen, water and their dissociation kinds and the incidence frequency of them to the emitter to low values.

The present inventors have found an atmosphere around the emitter required to obtain the field emission current stably, on the basis of results of experiments mainly using the emitter of STM (scanning tunneling microscopy). The state in which the atmosphere around the emitter should assume depends on the emitter material. However, the present inventors have found that it is possible to emit electrons stably, even if silicon (Si) for which the surface oxide film can be formed easily is used, as long as the relation X≦1.25×10¹²×J is satisfied when J≧10⁴, where the oxygen molecule density in the atmosphere around the emitter is X (mols/cm3) and the electron current density emitted from the emitter is J (A/cm²). As for the meaning of the restriction of the range of J, the range of J required to significantly heat the medium is indicated. When the emission current has a value which does not cause significant heating, or when the emitter operation is in the stopped state, it does not make sense at all to prescribe the relation between X and J.

When the emitter is in the stopped state, a natural oxide layer or a physical adsorption layer is formed. If the above-described condition expression is satisfied, however, these layers are easily dissociated by the following emitter operation. The prescription of the relation between X and J described above provides a condition for preventing the emitter tip from being attacked and degraded by oxygen when emission current operation capable of significantly heating the medium is being conducted. The relation expression between X and J physically means that one oxygen molecule flows onto the surface of the emitter while 100 electrons are emitted from the emitter. It is a result of experimentally finding that with an inflow quantity of such a degree the inflow oxygen is dissociated again by heating or the like of the emitter surface caused by electron emission and the emitter surface is prevented from being degraded.

### First Embodiment

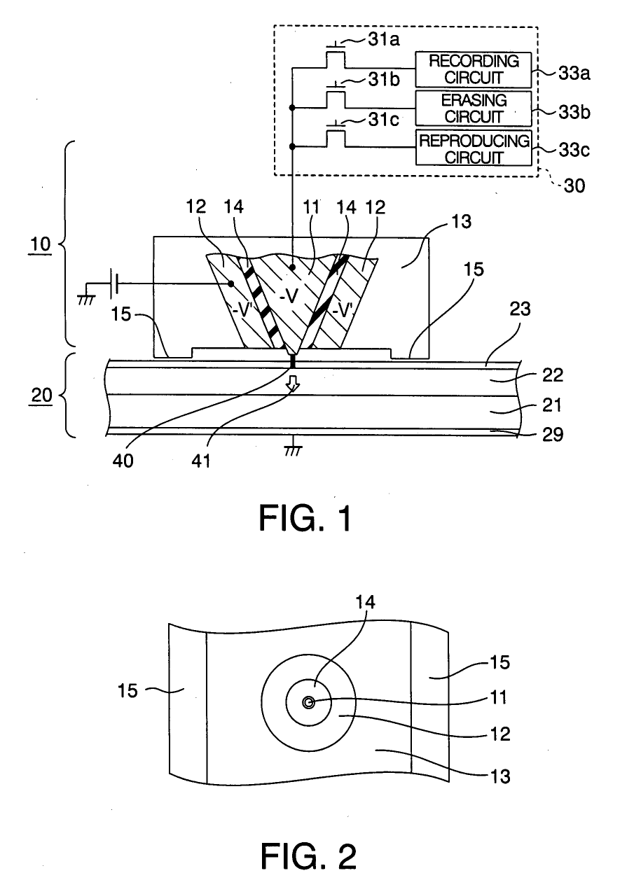

An information recording and reproducing apparatus according to a first embodiment of the present invention will now be described with reference to FIGS. 1 to 9. FIG. 1 is a sectional view of the information recording and reproducing apparatus according to the present embodiment. FIG. 2 is a plan view of the information recording and reproducing apparatus according to the present embodiment obtained by seeing it from a side opposite to the medium. The information recording and reproducing apparatus according to the present embodiment includes a head portion 10. The head portion 10 includes a first electrode 11 which emits an electron beam 40 by means of field emission, a second electrode 12 disposed around an electron emission end of the first electrode 11 so as to surround the first electrode 11 to stably emit electrons from the electron emission end of the first electrode 11 to a recording medium 20, and a head slider 13. The first electrode 11 and the second electrode 12 are electrically insulated from each other by an insulator 14. The first electrode 11 is connected to a record-erase-reproduce control circuit 30.

The recording medium 20 is disposed on a medium opposing face 15 side of the head slider 13. The recording medium 20 includes a medium substrate 21 formed of, for example, Si or the like, a recording layer 22 provided on the head slider 13 side of the medium substrate 21, a medium protection layer 23 provided on the recording layer 22 to protect the recording layer 22, and a conductive layer 29 provided across the medium substrate 21 from the head slider 13. The conductive layer 29 is electrically grounded. The recording layer 22 is formed of a material selected from a chalcogen compound, a perovskite material, a spinel material and a magnetic material.

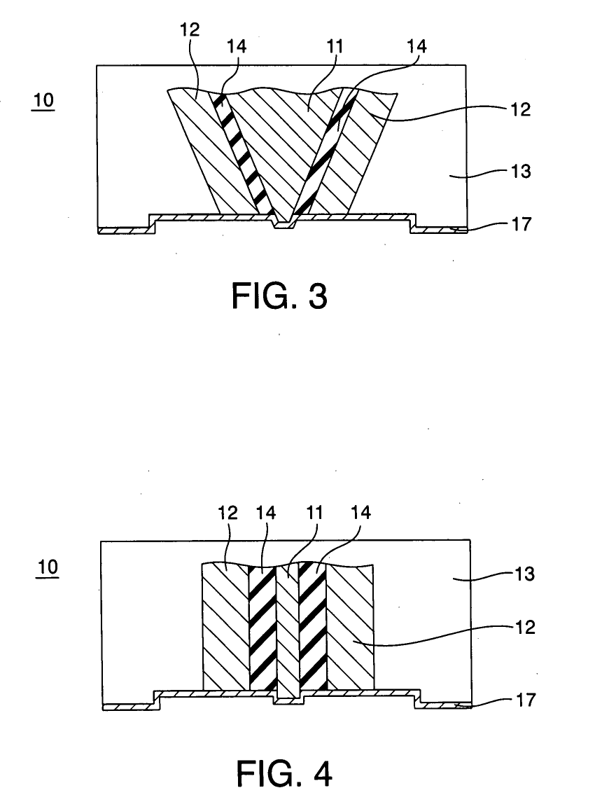

On the other hand, for the first electrode 11, a high melting point metal such as MO, W or Ta, a semiconductor such as Si or Ge, or C (carbon) can be used. In obtaining a stable electron emission life in the atmosphere, it is suitable to use C. It is more suitable to use especially a carbon nano-tube. Furthermore, it is basically desirable that the first electrode 11 takes a needle-like shape. The first electrode 11 may take the shape of, for example, a cone (having a triangular section) as shown in FIG. 3 or the shape of a column or a rectangular parallelepiped (having a rectangular section) as shown in FIG. 4. The shape of the electron emission end of the first electrode 11 seen from the medium opposing face 15 may be any of a circle, an ellipse, and a rectangle. It is important to sharpen the tip to approximately 10 nm. In implementation, the electric field strength at the tip of the electron emission source is important. Therefore, it is not desirable to bring the head 10 into floating operation because the floating quantity variation causes the electric field variation. Therefore, it is desirable to cause the slider 13 functioning as the head support member to take the shape of a contact pad to make contact operation possible. In the case of the contact operation, there is no floating quantity vibration and a load variation acts between the head 10 and the recording medium 20. It is desirable to cover the medium opposing face 15 serving as a sliding face of the head 10 by a DLC (diamond-like carbon) film 17 having an extremely thin thickness, for example, a thickness of approximately 5 nm with the object of protection of the head 10 as shown in FIG. 3 and FIG. 4. As for the recording medium 20, it is desirable to provide a lubrication layer on the protection film 23 although not illustrated in FIG. 1.

The method of recording, erasing and reproducing in the information recording and reproducing apparatus according to the present embodiment will now be described. As shown in FIG. 1, the record-erase-reproduce control circuit 30 includes selection transistors 31a, 31b and 31c, a recording circuit 33a, an erasing circuit 33b, and a reproducing circuit 33c. A first end of the selection transistor 31a is connected to the first electrode 11, and a second end of the selection transistor 31a is connected to the recording circuit 33a. A first end of the selection transistor 31b is connected to the first electrode 11, and a second end of the selection transistor 31b is connected to the erasing circuit 33b. A first end of the selection transistor 31c is connected to the first electrode 11, and a second end of the selection transistor 31c is connected to the reproducing circuit 33c. One of the recording circuit 33a, the erasing circuit 33b and the reproducing circuit 33c is selected by controlling a voltage applied to gates of the selection transistors 31a, 31b and 31c, and the recording, erasing or reproducing operation is conducted.

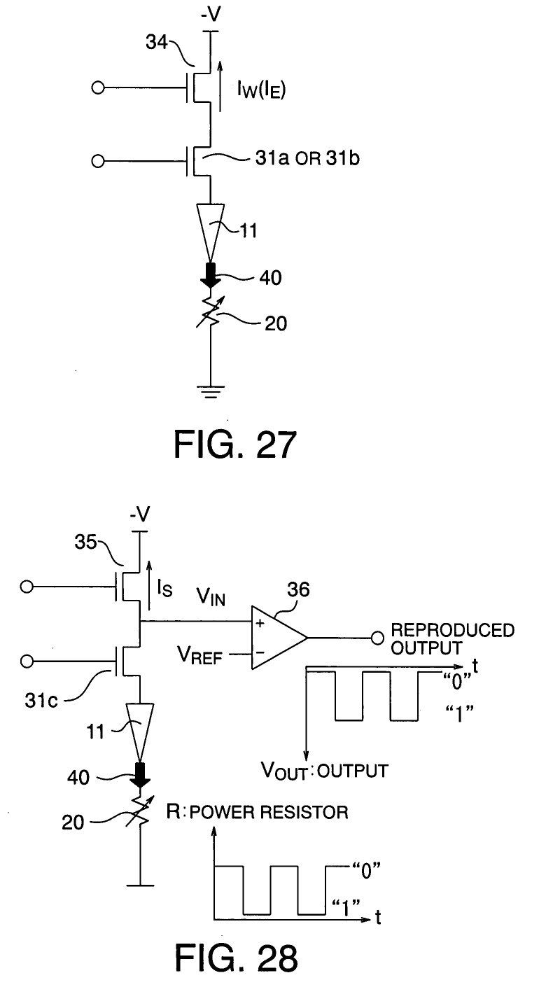

As shown in FIG. 27, each of the recording circuit 33a and the erasing circuit 33b includes a transistor 34 connected at a first end to a power supply having a potential of −V and connected at a second end to the selection transistor 31a or 31b. By applying a voltage to the transistor 34 at its gate, a recording current I_{W} flows in the case of the recording circuit 33a and an erasing current I_{E} flows in the case of the erasing circuit 33b.

As shown in FIG. 28, the reproducing circuit 33c includes a transistor 35 which is connected at its first end to a power supply having a potential of −V and connected at its second end to the selection transistor 31c, and a sense amplifier 36 which is supplied at its first input terminal with a potential V_{IN} from a connection node between the transistor 35 and the selection transistor 31c. A reference voltage V_{REF} is input to a second input terminal of the sense amplifier 36.

In recording, the selection transistor 31a in the record-erase-reproduce control circuit 30 is selected and the transistor 34 in the recording circuit 33a is turned on. As a result, a predetermined negative voltage is applied to the first electrode 11. Field emission of the electron beam 40 is conducted from the electron emission end of the first electrode 11. At this time, a predetermined voltage (a negative voltage which is different from the negative voltage applied to the first electrode 11 in FIG. 1) is applied to the second electrode 12 disposed so as to emit the electron beam 40 from directly under the first electrode 11 to a predetermined position on the recording medium 20 to brake the electron beam 40. Thereupon, the electron beam 40 is applied from the first electrode 11 to the recording medium 20, and a recording current 41 flows through a recording portion in the recording layer 22 of the recording medium 20. The recording portion in the recording layer 22 of the recording medium 20 is heated by the recording current 41, and the temperature at the recording portion rises. As a result, physical characteristics of the recording portion in the recording layer 22 are changed, and information recording is executed. If the recording layer 22 is made of a chalcogen compound such as GeSbTe (which is hereafter supposed to assume the amorphous state as its original state), then a phase change (from the amorphous state to the crystal state) is caused in the recording layer 22 by heating and a resultant temperature rise, and information recording is executed.

At the time of erasing, the selection transistor 31b in the record-erase-reproduce control circuit 30 is selected and the transistor 34 in the erasing circuit 33b is turned on. As a result, the voltage applied to the first electrode 11 at the time of recording and its application history are changed. Thus, the phase changes from the crystal state to the amorphous state in contrast with the change at the time of recording, and consequently information erasing is conducted.

At the time of reproducing, a voltage lower than that at the time of recording or erasing (a voltage which does not cause a phase change in the recording portion) is applied to the first electrode 11 while a predetermined voltage is being applied to the second electrode 12. At this time, the selection transistor 31c is selected and the transistor 35 in the reproducing circuit 33c is turned on. Thereupon, the electron beam 40 emitted from the first electrode 11 is subjected to braking force caused by influence of the electric field from the second electrode 12, and consequently the electron beam 40 is applied to the recording portion in the recording layer 22 accurately. As a result, a current flows through the recording portion in the recording layer 22. If the first electrode 11 and the recording medium 20 relatively moves, electric resistance in the recording layer 22 greatly changes according to whether there is recording. The change is detected by the record-erase-reproduce control circuit 30 as a voltage change. Even if the recording portion has a size of approximately 10 nm, therefore, it becomes possible to reproduce the recorded signal with a high SN ratio. By the way, the electric resistance in the recording layer 22 changes by three digits to five digits according to whether the recording is conducted or erasing is conducted.

It is a matter of course that the shape, material and arrangement position of the second electrode 12 and the sign and magnitude of the voltage applied to the second electrode 12 may be changed suitably in any way as occasion demands as long as the electron beam 40 is emitted stably. In addition, it is also necessary in some cases to prevent an unnecessary electron beam from being emitted among the second electrode 12, the first electrode 11 and the recording medium 20 by optimizing the distance between the second electrode 12 and the first electrode 11, the distance between the second electrode 12 and the recording medium 20, and the sign and magnitude of the voltage applied to the second electrode.

As evident from the conditions of the field emission type described prior to the description of the present embodiment, it is desirable for effective field emission of the electron beam that the first electrode 11 emits electrons in a gas atmosphere substantially having an atmospheric pressure and the spacing between the first electrode 11 and the recording medium 20 is shorter than the mean free path of electrons emitted from the electron emission end of the first electrode. To be more precise, it is desirable that the following condition is satisfied.

d<λmin×(760/P)

Here, the distance between the electron emission end of the first electrode 11 and the recording medium 20 is d (nm), the minimum value of the mean free path of electrons under 1 atm is λmin (nm), and the pressure of the gas atmosphere is P (Torr). It is desirable that this condition is satisfied not only in the present embodiment but also in second to fifth embodiments which will be described later.

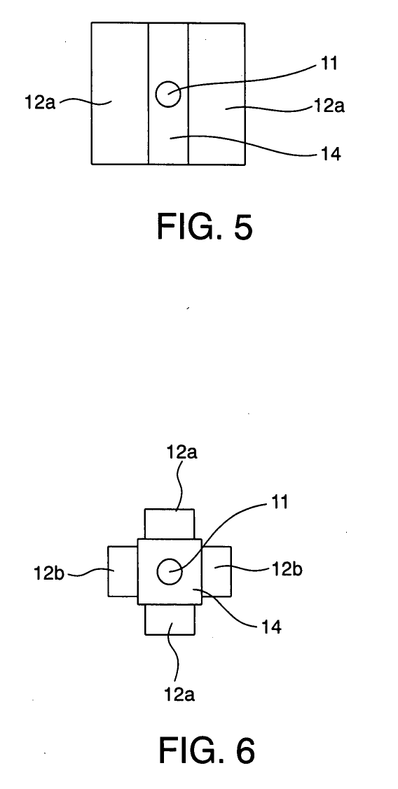

In the present embodiment, field emission of the electron beam 40 from the first electrode 11 onto the recording medium 20 is made more stable by disposing the second electrode 12 so as to surround the first electrode 11. As occasion demands, however, a pair of second electrodes 12a obtained by dividing the second electrode 12 as shown in FIG. 5 may be disposed around the first electrode 11 so as to have the first electrode 11 between. As shown in FIG. 6, at least two pairs of second electrodes 12a and 12b may be disposed around the first electrode 11. FIG. 5 and FIG. 6 are diagrams showing the first and second electrodes seen from the recording medium 20. It is possible to control irradiation of the recording portion in the recording layer 22 with the electron beam 40 more precisely and more stably as compared with the case shown in FIG. 1 by disposing at least two pairs of second electrodes 12a and 12b around the first electrode 11 as shown in FIG. 6. In FIG. 5 and FIG. 6 as well, the first electrode 11 is electrically insulated from the second electrodes 12a and 12b by the insulator 14. The relation between the first and second electrodes shown in FIG. 5 or FIG. 6 may be satisfied not only in the present embodiment, but also in the second to fifth embodiments which will be described later.

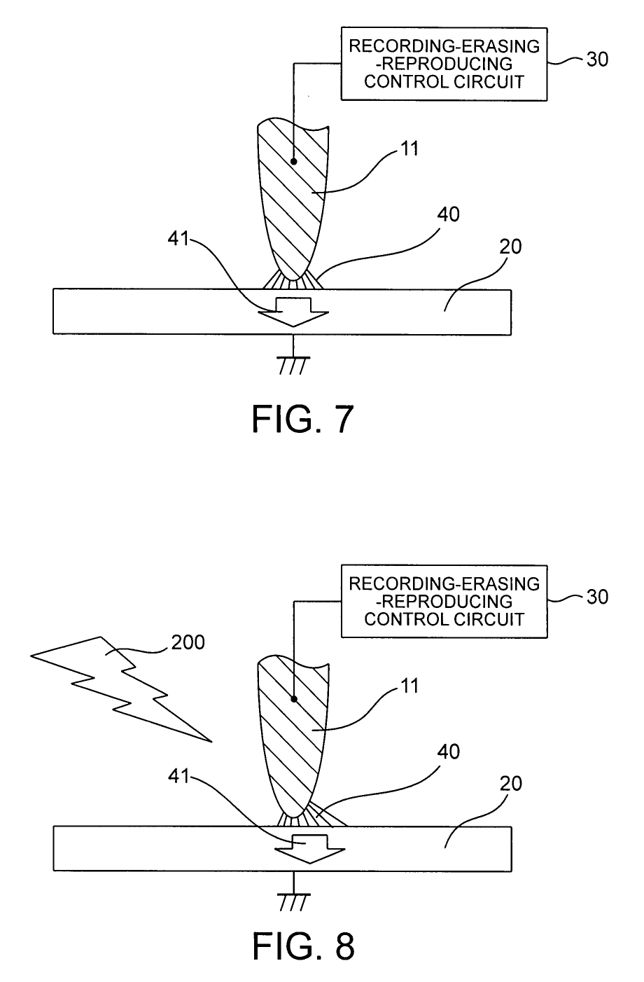

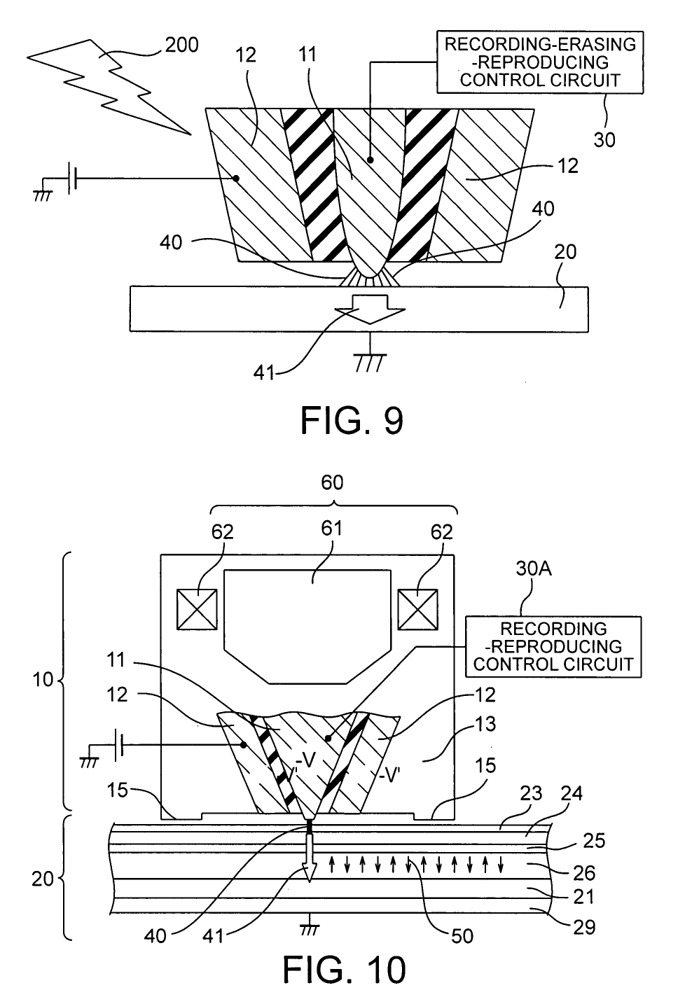

As shown in FIG. 7, it is desirable that the electron beam 40 generated by field emission is emitted directly under the probe electrode (first electrode) 11. Since the probe electrode 11 is subjected to electromagnetic disturbance 200, or influence of the surface roughness of the surface of the recording medium 20 or the tip of the probe electrode 11 as shown in FIG. 8, however, the irradiation position and irradiation strength of the electron 40 beam become apt to vary. In the present embodiment, the second electrode 12 is disposed around the first electrode 11 to control the electron beam 40 as shown in FIG. 9. Even under the electromagnetic disturbance 200, therefore, it becomes possible to hold down the variation of the irradiation position and the irradiation strength of the electron beam 40 onto the recording portion on the recording medium 20. Even if the irradiation region is made minute, therefore, stable electron beam irradiation can be conducted. As a result, it becomes possible to reproduce the recorded signal with a high SN ratio, and the recording density can be improved by leaps and bounds.

### Second Embodiment

A sectional view of an information recording and reproducing apparatus according to a second embodiment of the present invention is shown in FIG. 10. In the recording medium 20 used in the information recording and reproducing apparatus according to the first embodiment, the phase change material is used as the recording layer 22. In the recording medium 20 used in the information recording and reproducing apparatus according to the present embodiment, however, a magnetic substance is used as the recording layer. Therefore, the information recording and reproducing apparatus according to the present embodiment has a configuration obtained by newly providing a magnetic field applying portion 60 in the head 10 in the information recording and reproducing apparatus according to the first embodiment. The magnetic field applying portion 60 includes a magnetic pole 61 and a coil 62 which excites the magnetic pole 61 by means of a current magnetic field. Furthermore, in the configuration according to the present embodiment, the record-erase-reproduce control circuit 30 shown in FIG. 1 is replaced by a record-reproduce control circuit 30A. The record-reproduce control circuit 30A includes the recording circuit and the reproducing circuit included in the record-erase-reproduce control circuit 30 shown in FIG. 1.

On the other hand, the recording medium 20 used in the present embodiment includes an electrode layer 29 provided on the back of the medium substrate 21 and electrically grounded, a magnetic recording layer 26 provided on the surface of the medium substrate 21, a non-magnetic intermediate layer 25 provided on the magnetic recording layer 26, a polarized spin control layer 24 provided on the non-magnetic intermediate layer 25, a protection layer 23 provided on the polarized spin control layer 24, and a lubrication layer (not illustrated) provided on the protection layer 23. The first electrode 11 serving as electron irradiation means is provided on the polarized spin control layer 24 side of the recording medium 20. The first electrode 11 is provided at a distance of 10 nm from the magnetic recording medium 20 in order to emit an electron beam of a sufficient quantity to record and reproduce information.

Basic operation of the information recording and reproducing apparatus according to the present embodiment is conducted in the same way as that described with reference to the first embodiment. Braking force is applied to the electron beam emitted from the electron emission end of the first electrode 11 by applying a voltage to the first electrode 11 under the control of the record-reproduce control circuit 30A with a predetermined voltage applied to the second electrode 12 provided so as to surround the first electrode (probe electrode) 11. The stable electron beam 40 from the first electrode 11 is applied to the magnetic recording medium 20. A current supplied to the magnetic recording medium 20 thereby is passed through the polarized spin control layer 24 and changed to a spin-polarized current 41. Recording is conducted by inverting magnetization in the magnetic recording layer 25 by using the spin-polarized current 41. As for the direction of magnetization to be recorded, the polarized spin control layer 24 is controlled by a magnetic field given by the magnetic field applying portion 60 provided in the head 10. At the time of reproduction, the record-erase-reproduce control circuit 30 conducts reproduction by utilizing magnetoresistance effects (GMR: Giant Magnetoresistance Effect, TMR: Tunneling Magnetoresistance Effect, and BMR: Ballistic Magnetoresistance Effect) obtained by relative angles between magnetization in the polarized spin control layer 24 and magnetization in the magnetic recording layer 26.

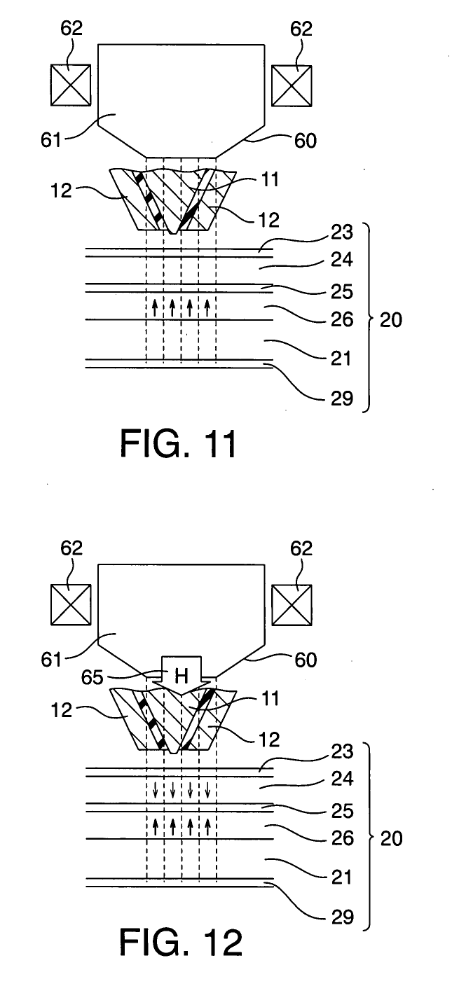

Hereafter, the principle of recording and reproducing in the information recording and reproducing apparatus according to the present embodiment will be described in detail with reference to FIGS. 11 to 23.

First, the case where recording is conducted will now be described. A section of the information recording and reproducing apparatus including the recording medium 20 in the initial state is shown in FIG. 11. In this initial state, all magnetizations in the magnetic recording layer 26 are directed upward. At this time, magnetization directions in the polarized spin control layer 24 are not especially determined.

Subsequently, as shown in FIG. 12, the record-reproduce control circuit 30A causes the magnetic field applying portion 60 to generate a downward magnetic field 65, and generates downward magnetizations in the polarized spin control layer 24. A region where the magnetic field 65 is applied is in a range indicated by dotted lines, and the region corresponds to four recording bits. The magnetic field 65 from the magnetic field applying portion 60 does not exert influence upon the magnetizations in the magnetic recording layer 26.

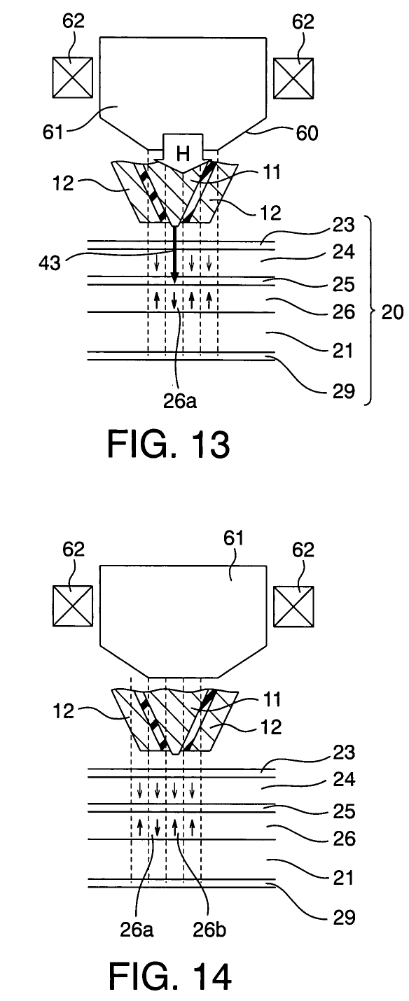

In a state in which the polarized spin control layer 24 is magnetized downward, the record-reproduce control circuit 30A applies a voltage to the first electrode 11. As a result, electrons 43 are supplied from the first electrode 11 toward the recording medium 20 as shown in FIG. 13. The supplied electrons 43 are spin-polarized in a specific direction (downward in FIG. 13) by the polarized spin control layer 24. When the spin-polarized electrons 43 pass through a 1-bit recoding portion 26a in the magnetic recording layer 26, the spin-polarized electrons 43 change the direction of the magnetization M in the recording portion 26a in the magnetic recording layer 26 to the spin-polarized direction of the electrons.

Subsequently, as shown in FIG. 14, the magnetic field applying portion 60 and the first electrode 11 are moved to conduct writing into a recording portion 26b subsequent to the recording portion 26a. In FIG. 14, the magnetic field applying portion 60 and the first electrode 11 are moved. Alternatively, the magnetic recording medium 20 may be moved.

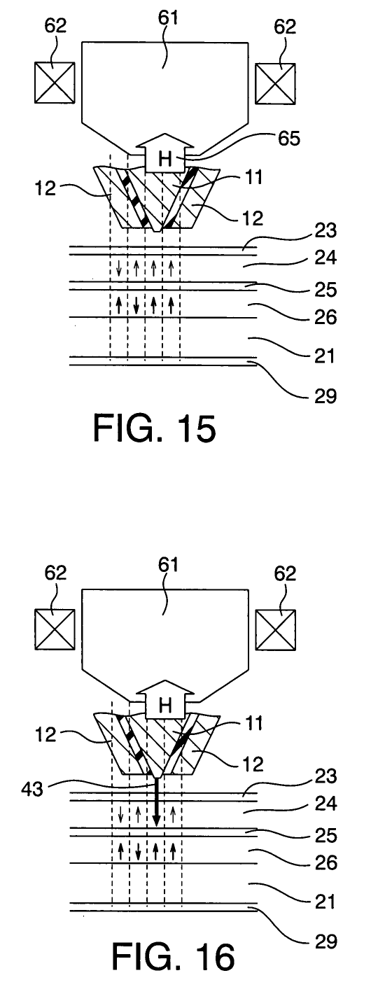

Subsequently, in order to write information corresponding to upward magnetization direction into the recording portion b, an upward magnetic field is generated by the magnetic field applying portion 60 as shown in FIG. 15 and magnetization in the polarized spin control layer 24 is made upward. In this state, the record-reproduce control circuit 30A applies a voltage to the first electrode 11 and supplies electrons 43 from the first electrode 11 toward the recording medium 20 as shown in FIG. 16. The supplied electrons 43 are spin-polarized upward by the polarized spin control layer 24. When the spin-polarized electrons 43 pass through the magnetic recording layer 26, the spin-polarized electrons 43 change the direction of the magnetization in the magnetic recording layer 26 to upward.

In other words, the polarized spin control layer 24 used in the magnetic recording medium 10 has a function of converting the current 43 supplied from the first electrode 11 to the spin-polarized current. When the spin-polarized current has become greater than a threshold, magnetization in the magnetic recording layer 12 can be inverted. This threshold depends upon an anisotropic magnetic field Hk, and depends upon an external magnetic field H and saturated magnetization Ms as well.

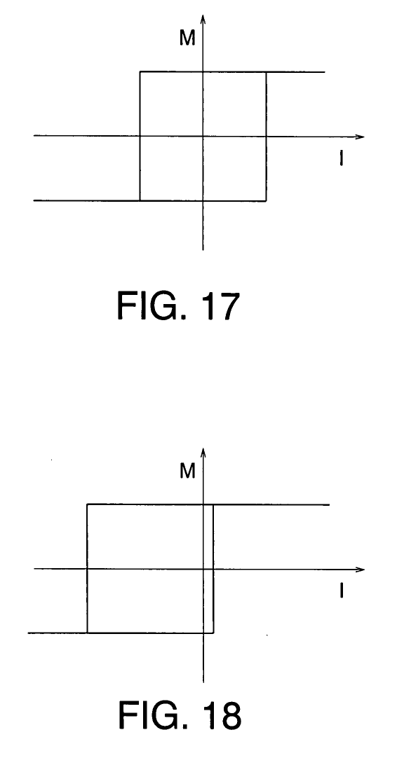

FIG. 17 is a graph representing an ideal current-magnetization curve in the magnetic recording layer 26. The abscissa indicates a spin-polarized current supplied to the magnetic recording layer 26, and the ordinate indicates magnetization M in the recording layer. As evident from FIG. 17, the curve behaves in the same way as an ordinary M-H curve of a ferromagnetic substance measured by a VSM (Vibrating Sample Magnetometer) or the like. In other words, if the spin-polarized current I exceeds a certain threshold, magnetization M occurs. On the other hand, the current threshold depends upon the external magnetic field. In other words, the current-magnetization curve exemplified in FIG. 17 is shifted in the abscissa axis direction by the external magnetic field.

FIG. 18 is a graph exemplifying a current-magnetization curve of the magnetic recording layer 26 in the state in which the external magnetic field H is applied. The abscissa axis indicates the spin-polarized current supplied to the magnetic recording layer 26, and the ordinate axis indicates the magnetization M in the recording layer. As appreciated from FIG. 18, the threshold of the spin-polarized current for generating magnetization M in the magnetic recording layer 26 can be controlled by the external magnetic field H.

In the present embodiment, the direction of the spin polarization in the polarized spin control layer 24 is controlled by the magnetic field from the magnetic field applying portion 60 as heretofore described. When passing through the polarized spin control layer 24, the electrons supplied from the first electrode 11 are polarized in spin to the direction of spin polarization in the polarized spin control layer 24. The electrons are supplied to the magnetic recording layer 26 to write magnetization M depending upon the spin direction therein. Thereafter, the write current flows to the ground via the electrode layer 29. At this time, it is also possible to control the write threshold for the spin polarization current in the magnetic recording layer 26 by using the external magnetic field given by the magnetic field applying portion 60 as described with reference to FIG. 18.

According to the present embodiment, it is not necessary to restrict the magnetic field generated from the magnetic field applying portion 60 especially to a minute range. And it is possible to conduct writing into only an extremely minute range in the magnetic recording layer 26 by using a local current supplied from the minute electron emission end of the first electrode 11. In other words, ultra-high density magnetic recording enhanced in recording density by leaps and bounds as compared with the conventional art becomes possible.

On the other hand, readout of information thus recorded can be conducted by utilizing the magnetoresistive effect. In other words, resistance between the magnetic recording layer 26 and the polarized spin control layer 24 is measured. If the magnetization direction in the magnetic recording layer 26 is parallel to the magnetization direction in the polarized spin control layer 24 (magnetizations are in the same direction), then the resistance is low. If the magnetization direction in the magnetic recording layer 26 is antiparallel to the magnetization direction in the polarized spin control layer 24 (magnetizations are different from each other by 180 degrees), then the resistance is high.

It becomes possible to control the magnetization direction in the polarized spin control layer 24 so as to make it the predetermined direction by using the magnetic field applying portion 60. As a result, the magnetization direction in the magnetic recording layer 26 can be known by letting a current flow and detecting a resistance change under the control of the record-reproduce control circuit 30A. Here, the current at the time of readout (the time of reproducing) must be smaller than the current at the time of writing. This is made possible by making the magnitude of the voltage applied to the first electrode 11 at the time of reproducing smaller than that at the time of recording or erasing and thereby decreasing the quantity of the electron beam emitted from the electron emission end of the first electrode 11. This is because the magnetization in the recording layer 26 is inverted and information is lost if the current at the time of readout is greater than that at the time of writing. In the present embodiment, however, it is necessary to apply a magnetic field to the polarized spin control layer 24 by using the magnetic field applying portion 60 at the time of reproducing as well.

Hereafter, each of the magnetic recording medium 20, the first electrode 11, the second electrode 12 and the magnetic field applying portion 60 used in the present embodiment will be described in detail.

First, the magnetic recording medium 20 will now be described. Besides the basic components exemplified in FIG. 10, an underlying layer (not illustrated) for controlling performance (such as the crystal structure and orientation characteristics) of the magnetic recording layer 26 may be provided in the magnetic recording medium 20 as occasion demands. Furthermore, as exemplified in FIG. 10, the protection layer 23 formed of carbon (C) or SiO₂ may be provided on the magnetic recording layer 26 or the polarized spin control layer 24 as occasion demands.

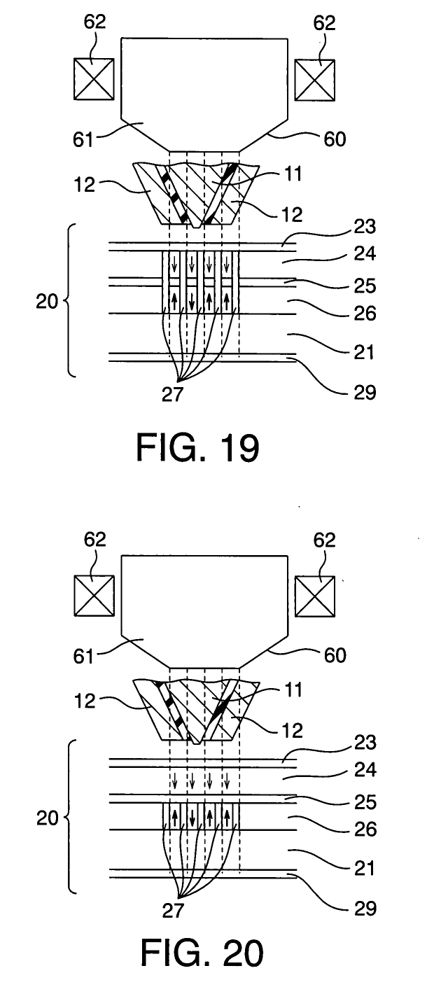

The magnetic recording medium 20 may have a structure separated into a plurality of regions in an in-plane direction. FIG. 19 is a schematic diagram representing the recording medium thus separated. In other words, in the magnetic recording medium 20 exemplified in FIG. 19, each of the magnetic recording layer 26, the non-magnetic intermediate layer 25 and the polarized spin control layer 24 provided on the substrate 21 which is electrically grounded is divided into a plurality of independent portions by separation regions 27. The separation regions 27 may be formed of non-magnetic or electrically insulating materials.

If the medium is divided into a plurality of portions by the separation regions 27, it becomes possible to prescribe the recording bit size certainly and suppress occurrence of “protrusion” of the recording region, cross-talk, cross-erase and so on.

It is not always necessary to divide the whole of the magnetic recording layer 26, the non-magnetic intermediate layer 25, and the polarized spin control layer 24 by using the separation regions 27. For example, in the case of the magnetic recording medium exemplified in FIG. 20, only the magnetic recording layer 26 is divided into a plurality of independent portions by the separation regions 27. In this case as well, the separation regions 27 can be formed of non-magnetic or electrically insulating material, and an effect that the recording bit size can be prescribed accurately is obtained. Even if the separation regions 27 are provided only in the non-magnetic intermediate layer 25 or the polarized spin control layer 24 in the same way, it becomes possible to prescribe the size of the recording bit region by using the confined current path action or the like.

In any of the magnetic recording media heretofore described, a material having large magnetic anisotropy is suitable as the material of magnetic particles used in the magnetic recording layer 26. From this viewpoint, it is desirable to use an alloy of a magnetic element selected from a group including cobalt (Co), ferrum (Fe) and nickel (Ni) with metal selected from a group including platinum (Pt), samarium (Sm), chromium (Cr), manganese (Mn), bismuth (Bi) and aluminum (Al), as the magnetic metal material.

Especially, a cobalt (Co) group alloy having large crystal magnetic anisotropy is more desirable. In particular, an alloy based on CoPt, SmCo or CoCr, or a regular alloy such as FePt or CoPt is more desirable. Specifically, Co—Cr, Co—Pt, Co—Cr—Ta, Co—Cr—Pt, Co—Cr—Ta—Pt, Fe₅₀Pt₅₀, Fe₅₀Pd₅₀, and CO₃Pt are mentioned.

Furthermore, as the magnetic material, a rare-earth (RE)—transition metal (TM) alloy such as Tb—Fe, Tb—Fe—Co, Tb—Co, Gd—Tb—Fe—Co, Gd—Dy—Fe—Co, Nd—Fe—Co or Nd—Tb—Fe—Co, a multi-layer film of a magnetic layer and a precious metal layer (such as Co/Pt and Co/Pd), a semimetal such as PtMnSb, or a magnetic oxide such as Co ferrite or Ba ferrite can be used.

In addition, in order to increase the magnetic characteristics of the above-described magnetic material, for example, copper (Cu), chromium (Cr), niobium (Nb), vanadium (V), tantalum (Ta), titanium (Ti), tungsten (W), hafnium (Hf), indium (In), silicon (Si), boron (B) and so on, or compounds of these elements and at least one kind of element selected from among oxygen (O), nitrogen (N), carbon (C) and hydrogen (H) may be added.

As for the magnetic anisotropy, any of the in-plane magnetic anisotropy used in the conventional HDD (Hard Disk Drives), vertical magnetic anisotropy used in magneto-optical recording, and a mixture of them may be used. As regards the magnetic anisotropy constant, a recording layer having a large magnetic anisotropy constant is used to break down the thermal fluctuation limit. In addition, it is also necessary to have Hc of such a degree that is not affected by the magnetic field from the magnetic head.

It is possible to use, as the magnetic recording layer 26, for example, a structure, in which a plurality of magnetic particles and a non-magnetic substance which buries gaps between the magnetic particles are included and the magnetic particles are scattered in the non-magnetic substance.

The method of dividing the magnetic particles by the non-magnetic substance is not especially restricted. For example, a method of adding non-magnetic elements to the magnetic material, forming a film, and precipitating a non-magnetic substance such as chromium (Cr), tantalum (Ta), boron (B), an oxide (such as SiO₂), or a nitride may be used.

Furthermore, a method of forming a minute hole through the non-magnetic substance by utilizing the lithography technique and burying magnetic particles in the holes may be used. Or a method of self-organizing diblock copolymer such as PS-PMMA, removing one kind of polymer, forming minute holes through a non-magnetic substance by using the other kind of polymer as a mask, and burying magnetic particles in the holes may be used. A method of conducting working using particles beam irradiation may be used.

The thickness of the magnetic recording layer 26 is not especially restricted. With due regard to making high density recording possible and letting a current flow, however, a thick film of 100 nm or more is not desirable. If it is attempted to set the thickness of the magnetic recording layer 26 equal to 0.1 nm or less, however, it becomes difficult to form the film in many cases. Therefore, it is necessary to determine the thickness of the magnetic recording layer 26 suitably according to the film forming technique in use as well.

The underlying layer (not illustrated) provided as occasion demands may be either of a magnetic substance and a non-magnetic substance. The thickness of the underlying layer is not especially restricted. If the thickness is greater than 500 nm, however, the manufacturing cost increases and consequently it is not desirable.

The non-magnetic underlying layer is provided with the object of controlling the crystal structure of a magnetic substance or a non-magnetic in the magnetic recording layer 26 or with the object of preventing impurities from being mixed in from the substrate. For example, if an underlying layer having a grating constant close to a grating constant of crystal orientation requested for the magnetic substance is used, then the crystal orientation of the magnetic substance can be controlled. Furthermore, it is also possible to control the crystal or amorphous property of the magnetic substance or the non-magnetic substance in the magnetic recording layer 26 by using an amorphous underlying layer having suitable surface energy.

An underlying layer having a different function may be further provided under the underlying layer. Since the two underlying layers can share the function in this case, the desired effect control becomes easy. For example, a technique of providing a seed layer having a small particle diameter on the substrate and providing an underlying layer which controls the crystal property of the recording layer on the seed layer with the object of making the crystal particles in magnetic recording layer 26 small is known. It is desirable to use a thin film which is small in grating constant or minute as the underlying layer in order to prevent impurities from being mixed in from the substrate.

The polarized spin control layer 24 has a role of converting the current from the first electrode 11 to a spin-polarized current in a direction of magnetization M to be recorded on the magnetic recording layer 26. The direction of the magnetization M, i.e., the direction of spin polarization in the polarized spin control layer 24 can be controlled by the magnetic field from the magnetic field applying portion 60. Therefore, it is desirable to form the polarized spin control layer 24 of a soft magnetic substance capable of responding to the magnetic field from the magnetic field applying portion 60 rapidly. Furthermore, it is desirable to form the polarized spin control layer 24 of a material having a high degree of spin polarization in order to conduct spin polarization certainly. Here, the degree P of spin polarization is a difference in state density between up spin electrons and down spin electrons. And the degree P is represented by the following expression.

P=(D(↓)−D(↑))/(D(↓)+D(↑))

Here, D(↑) and D(↓) represent the state density of up spin electrons and the state density of down spin electrons, respectively.

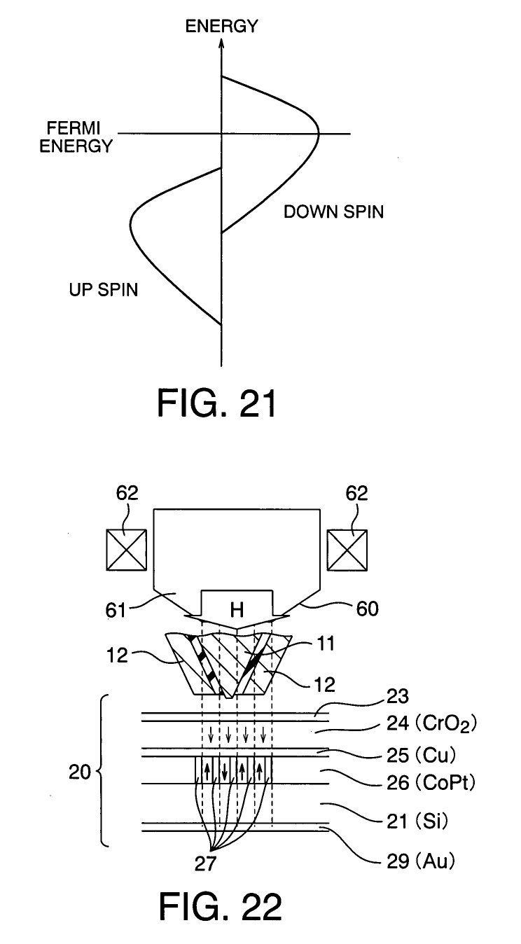

As a material having a large degree P of spin polarization, a substance called “half metal” is known. Its degree of spin polarization is 1.0. In other words, only down spin electrons have a state density near the Fermi energy as shown in FIG. 21. A perovskite structure ferromagnetic oxide, a rutile structure ferromagnetic oxide, a spinel ferromagnetic oxide, a pyrochlore ferromagnetic oxide including at least cobalt (Co), iron (Fe) and nickel (Ni), and a magnetic semiconductor thin film including a material selected from at least titanium (Ti), vanadium (V), chromium (Cr), manganese (Mn), iron (Fe), cobalt (Co) and nickel (Ni) are known as materials which exhibits the half metal property. These materials can be used in the polarized spin control layer 24. Besides, a single substance of iron (Fe), cobalt (Co) and nickel (Ni), or an alloy including at leas one of iron (Fe), cobalt (Co) and nickel (Ni) can also be used in the polarized spin control layer 24, because it indicates a finite degree P of spin polarization.

The thickness of the polarized spin control layer 24 is not especially restricted. With due regard to achieving high density recording and letting a current flow in the vertical direction, however, a thick film of 100 nm or more desirable. If it is attempted to set the thickness of the polarized spin control layer 24 equal to 0.1 nm or less, however, it is not easy to form the film. Therefore, it is necessary to determine the thickness of the magnetic recording layer 26 suitably by taking a film forming technique as well into consideration. As for the polarized spin control layer 24, for example, a structure in which a plurality of magnetic particles and an insulator which buries gaps between the magnetic particles are included and the magnetic particles are scattered in the insulator may be used. If such a structure is used, it is possible to prevent the current in a direction perpendicular to the film face from scattering in the in-plane direction.

The non-magnetic intermediate layer 25 is provided with the object of preventing the magnetization in the polarized spin control layer 24 and magnetization in the magnetic recording layer 26 from conducting exchange coupling. It is known that the magnitude of the exchange coupling attenuates as the distance between them increases. From this viewpoint, it is desirable that the non-magnetic intermediate layer 25 is thick. Considering that recording is conducted on the magnetic recording layer 26 by using the spin-polarized current, the polarization direction of the spin-polarized current must be preserved. Therefore, the thickness of the non-magnetic intermediate layer 25 must be shorter than the mean free path of that material. For example, if the non-magnetic intermediate layer is formed of copper (Cu), the mean free path of copper (Cu) is approximately 10 nm. If the distance is at least 3 nm, the exchange coupling can be neglected. Therefore, it is desirable that the thickness of the non-magnetic intermediate layer 25 utilizing copper (Cu) is in the range of 3 to 10 nm.

As for means which stably lets a current to a minute recording region on the magnetic recording medium 20, it is desirable to apply electrons from the first electrode 11 by means of field emission in a state in which a predetermined voltage is applied to the second electrode 12 formed of a conductor which is disposed around the first electrode 11 formed of a conductor or a semiconductor disposed in the head portion 10. Suitable braking force is exerted on the electrons by suitably selecting the shape, disposition and applied voltage of the second electrode 12. Even under the influence of electromagnetic disturbance, therefore, it becomes possible to apply the electron beam to a desired irradiation position on the recording medium 20 with a constant intensity.

As the probe electrode (the first electrode) in this case, a needle-shaped electrode formed of metal or semiconductor or an electrode having a projection at its tip can be used. A minute structure such as a “carbon nano-tube” can also be used.

As for means which applies a magnetic field to the magnetic recording medium 20, a magnetic circuit including an induction coil and a magnetic pole on an end face of a contact slider expected to be used in HDDs from now on may be used. A permanent magnet may be installed. An instantaneous local magnetic field may be generated by adding a magnetic layer to the medium and generating magnetization distribution by means of temperature distribution or light irradiation. Or a leak magnetic field generated from the magnetic layer itself which conducts information recording may be used.

If a permanent magnet is installed, it becomes possible to conduct fast, high density magnetic field applying by conducting a contrivance such as making the distance from the magnetic recording medium 20 variable or making the magnet minute.

### EXAMPLE

Hereafter, an example of the magnetic recording and reproducing apparatus according to the present embodiment will be described in detail.

FIG. 22 is a sectional view showing a configuration of the present example. The recording medium 20 is fabricated by using chromium oxide (CrO₂) which exhibits the rutile structure as the polarized spin control layer 24, using cobalt platinum (CoPt) as the magnetic recording layer 26, copper (Cu) as the non-magnetic intermediate layer 25, and using gold (Au) as the electrode layer 29. By the way, SiO₂ is used as the material of the separation regions 27 in the magnetic recording layer 26.

First, a gold (Au) electrode layer 29 is formed on the back side of a p-type silicon (Si) substrate 21. Subsequently, a magnetic recording layer 26 formed of cobalt platinum (CoPt) is formed on the silicon substrate 21. Copper (Cu) is grown on the magnetic recording layer 26 to form a non-magnetic intermediate layer 25. In addition, a polarized spin control layer 24 formed of chromium oxide (CrO₂) is formed on the non-magnetic intermediate layer 25. The thickness of cobalt platinum (CoPt) is set equal to approximately 20 nm. The thickness of copper (Cu) is set equal to 5 nm. The thickness of chromium oxide (CrO₂) is set equal to approximately 10 nm.

Subsequently, the surface of a short needle formed of silicon (Si) is coated with gold (Au). A resultant needle is used as the first electrode 11 (field emission probe). The first electrode 11 takes the shape of a cone, and the diameter of its tip is approximately 10 nm. In addition, a magnetic field applying unit 60 is formed so as to be able to apply a magnetic field of 2 kOe. Coercive force Hc of a single layer of chromium oxide (CrO₂) and cobalt platinum (CoPt) similar to those used in the present example is measured by suing a VSM. Results of the measurement are 5000e and 25000e. The magnetic recording medium 20 in the present example exhibits a two-stage loop. Changes of the magnetization M are noticed near 5000e and 25000e. It is found that characteristic curves in which respective “Hc”s do not exert influence each other are obtained because layers of chromium oxide (CrO₂) and cobalt platinum (CoPt) do not conduct magnetically exchange coupling.

In other words, it can be confirmed that exchange coupling does not act between the polarized spin control layer 24 formed of chromium oxide (CrO₂) and the magnetic recording layer 26 formed of cobalt platinum (CoPt) by inserting a layer of copper (Cu) having a thickness of 5 nm as the non-magnetic intermediate layer 25. In addition, since the direction of the magnetic field H is perpendicular to the medium face, it can be simultaneously conformed that the easy axis direction of the magnetic recording layer 26 formed of cobalt platinum (CoPt) is perpendicular to the medium face.

Subsequently, an experiment of magnetic recording using spin-polarized current is conducted by using the above-described information recording and reproducing apparatus and the magnetic recording medium 20.

First, magnetizations in the polarized spin control layer 24 formed of chromium oxide (CrO₂) and the magnetic recording layer 26 formed of cobalt platinum (CoPt) are aligned upward. Magnetization in only the polarized spin control layer 24 formed of chromium oxide (CrO₂) is inverted by applying a downward magnetic field to this recording medium. In this state, electron beam irradiation is conducted from the first electrode 11, and the resistance in the magnetic recording medium 20 is measured at the same time. Before the electron beam irradiation is conducted, the resistance is high because the magnetization in the polarized spin control layer 24 formed of chromium oxide (CrO₂) is antiparallel to magnetization in the magnetic recording layer 26 formed of cobalt platinum (CoPt). A voltage of approximately 10 V is applied to the first electrode 11, and a field emission current of 1 mA is confirmed. At this time, the resistance value in the magnetic recording medium 20 falls by approximately 60 mΩ. From this fact, it is considered that the magnetization in the magnetic recording layer 26 formed of cobalt platinum (CoPt) is inverted by electron beam emission from the first electrode 11 and the resistance falls because the magnetization in the magnetic recording layer 26 has become parallel to the magnetization in the polarized spin control layer 24 formed of chromium oxide (CrO₂). In other words, it can be confirmed that recording on the magnetic recording layer 26 is conducted by electron beam irradiation from the first electrode 11.

If the medium recording portion is formed so as to be separated by the separation regions 27 formed of non-magnetic substance as in the present example, and ferrum platinum (FePt) having a higher magnetic anisotropy energy density (Ku) is used instead of cobalt platinum (CoPt) as the magnetic recording layer 26, then the recording portion can be made minute as compared with the case where CoPt is used, because FePt is strong against “thermal fluctuation.” If Ku is increased, then the current value required for spin injection recording increases. As the volume of the magnetic substance used for recording is decreased by a higher density, however, the current value required for recording (magnetization inversion) decreases remarkably. Even if the recording portion is made minute (increased in density), therefore, the magnitude of the spin current does not increase and spin injection recording at a low current value becomes possible.

A modification of the present embodiment will now be described.

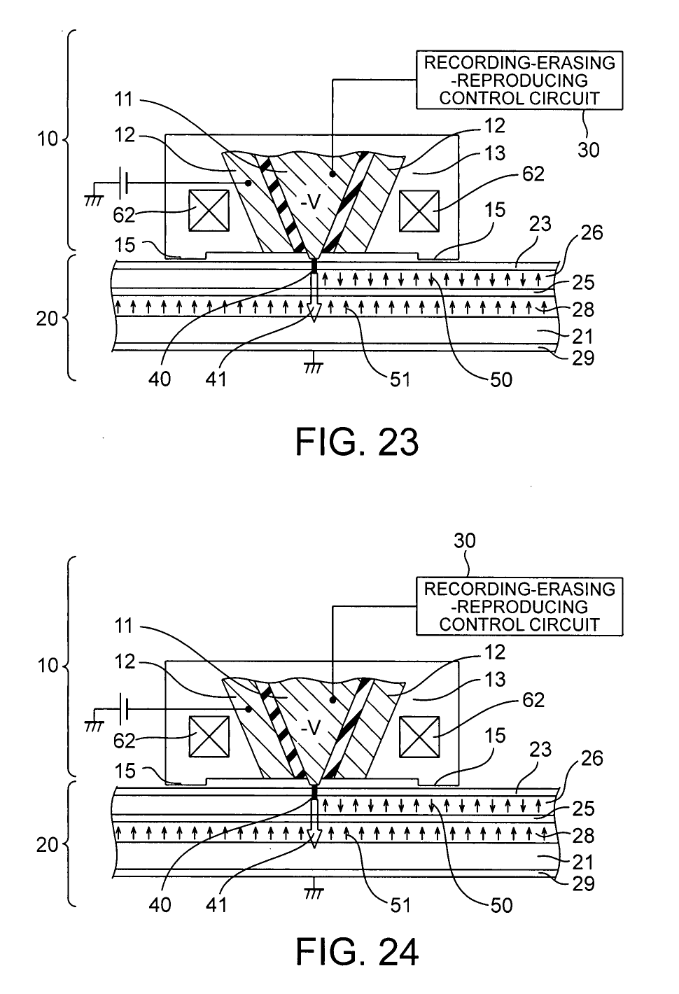

The direction of magnetization in the polarized spin control layer 24 in the magnetic recording medium 20 may be determined by using a configuration in which the coil 62 is magnetically coupled to the second electrode 12 formed of magnetic metal as the magnetic field applying portion as shown in FIG. 23. By adopting such a configuration, the configuration of the head portion 10 is simplified and a small-sized head portion can be implemented. Other configurations, actions and advantages are the same as those in the above-described example.

According to the present embodiment, the second electrode 12 which controls the electron beam 40 is disposed around the first electrode 11 as heretofore described. Even under the electromagnetic disturbance 200, therefore, it becomes possible to hold down the variation of the irradiation position and the irradiation strength of the electron beam 40 onto the recording portion on the recording medium 20. Even if the irradiation region is made minute, therefore, stable electron beam irradiation can be conducted. As a result, it becomes possible to reproduce the recorded signal with a high SN ratio, and the recording density can be improved by leaps and bounds.

### Third Embodiment

An information recording and reproducing apparatus according to a third embodiment of the present invention will now be described. In the same way as the information recording and reproducing apparatus according to the second embodiment, the information recording and reproducing apparatus according to the present embodiment conducts magnetic recording on the magnetic recording medium by means of spin injection. FIG. 24 is a sectional view of the information recording and reproducing apparatus according to the present embodiment.

The information recording and reproducing apparatus according to the present embodiment has a configuration obtained by removing the magnetic pole 61 in the second embodiment and causing the first electrode 11 used as the probe electrode for emitting the electron beam 40 by means of field emission to serve as a magnetic pole. In the present embodiment, therefore, the first electrode 11 is formed of a high polarized spin control material. For example, the first electrode 11 is formed of a material (such as half metal) which is the same as that of the polarized spin control layer 24 in the recording medium described with reference to the second embodiment.

In addition, the configuration of the magnetic recording medium 20 used in the information recording and reproducing apparatus according to the present embodiment differs from that in the second embodiment. In the magnetic recording medium 20, a magnetization pinned layer 28 formed of a high Ku material such as FePt is formed on a substrate 21 formed of p-type Si having an electrode layer 29 electrically grounded and formed of Au on the back. The magnetization pinned layer 28 is previously magnetized in one direction. A non-magnetic intermediate layer 25 formed of Cu, Cu oxide, Al₂O₃, or MgO is provided on the magnetization pinned layer 28. A magnetic recording layer 26 formed of, for example, CoPt is provided on the non-magnetic intermediate layer 25. A protection layer 23 formed of, for example, DLC is provided on the magnetic recording layer. A lubricant layer, which is not illustrated, is provided on the protection layer 23. The magnetization pinned layer 28, the non-magnetic intermediate layer 25 and the magnetic recording layer 26 form a magnetoresistive effect film.

In the information recording and reproducing apparatus according to the present embodiment having such a configuration, the record-reproduce control circuit 30A causes a current to flow through the coil 62 in a state in which a predetermined voltage is applied to the second electrode 12. The first electrode 11 is magnetized by a magnetic field which is generated by the current. The record-reproduce control circuit 30A applies a voltage to the first electrode 11. Thereupon, the electron beam 41 spin-polarized in the direction of the magnetization in the first electrode 11 is applied to the recording portion on the magnetic recording medium 20. The spin-polarized current 40 flows through the magnetic recording layer 26. The magnetization direction in the magnetic recording layer 26 becomes the same as the magnetization in the first electrode 11. As a result, information recording is conducted.

As for information erasing, the record-reproduce control circuit 30A lets a current flow through the coil 62 and applies a magnetic field having a polarity opposite to that at the time of recording, to the first electrode 11. As a result, the magnetization direction in the first electrode 11 is inverted. Thereafter, processing is conducted according to a procedure similar to that at the time of recording.

At the time of reproducing, the record-reproduce control circuit 30A applies a voltage to the first electrode 11 so as to emit an electron beam having such a level that spin injection to the magnetic recording layer 20 cannot be conducted, and moves the head portion 10 and the magnetic recording medium 20 relatively. Electric resistance in the magnetoresistive effect layer including the magnetic recording layer 26, the non-magnetic layer 25, and the magnetization pinned layer 28 changes remarkably according to whether there is recording in the magnetic recording layer. Therefore, the record-reproduce control circuit 30A detects this change as a voltage change and thereby reproduces the recorded signal. Unlike the second embodiment, in the present embodiment, it is not necessary at the time of reproducing to generate a magnetic field by using the magnetic field applying portion (the coil 61 in the present embodiment) and apply the magnetic field to the recording medium 20.

According to the present embodiment, the second electrode 12 which controls the electron beam 40 is disposed around the first electrode 11 as heretofore described. Even under the electromagnetic disturbance 200, therefore, it becomes possible to hold down the variation of the irradiation position and the irradiation strength of the electron beam 40 onto the recording portion on the recording medium 20. Even if the irradiation region is made minute, therefore, stable electron beam irradiation can be conducted. As a result, it becomes possible to reproduce the recorded signal with a high SN ratio, and the recording density can be improved by leaps and bounds.

### Fourth Embodiment

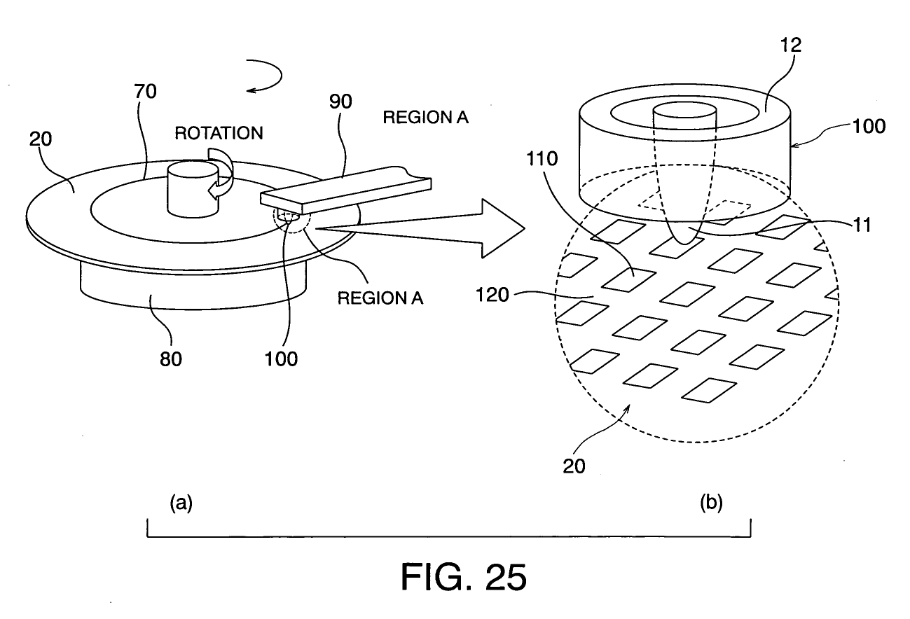

An information recording and reproducing apparatus according to a fourth embodiment of the present invention will now be described with reference to FIGS. 25(a) and 25(b). FIG. 25(a) is an oblique view for explaining a principal configuration of the information recording and reproducing apparatus according to the present embodiment. FIG. 25(b) is an enlarged view of a region A on a disk-like recording medium 20 shown in FIG. 25(a).

The information recording and reproducing apparatus according to the present embodiment includes a record-erase-reproduce probe 100 including a first electrode 11 to conduct field emission of an electron beam, and a second electrode 12 to exert braking force on the emitted electron beam and stabilize the emission of the electron beam, and a record-erase-reproduce circuit (not illustrated). A disk-like recording medium 20 is used as the recording medium 20. On the surface of the disk-like recording medium 20, recording bit regions 110 are separated by a separation region 120 and arranged regularly. By the way, each of the first electrode 11 and the second electrode 12 in the present embodiment may have the same configuration as that in any of the first to third embodiments. The record-erase-reproduce probe 100 is supported by a head suspension 90.

In the information recording and reproducing apparatus according to the present embodiment, the disk-like recording medium 20 is moved relatively to the record-erase-reproduce probe 100 by rotating the disk-like recording medium 20 by means of a spindle motor 80. Information recording, erasing and reproducing are conducted along a row of recording bit regions in the track direction, i.e., a recording track 70. By thus providing the recording medium 20 described in the first embodiment or the recording medium 20 described in the second or third embodiment with a disk-like shape, it becomes possible for the information recording and reproducing apparatus according to the present embodiment to conduct recording, reproducing and erasing with a larger capacity and at a higher speed.

By the way, the recording medium 20 used in the present embodiment has a recording medium structure in which the recording bit regions 110 are separated by the separation region 120 and two-dimensionally arranged regularly. Since a recording medium having such a structure is utilized, a current flowing to the medium via the first electrode 11 flows into only a separated recording bit region 110. Irrespective of the kind of the recording mechanism (such as recording of the physical state change of the recording layer caused by heating and temperature raising, and spin injection recording), it becomes possible to conduct recording or erasing in only the recording bit region 110 without causing cross erasing in adjacent bit regions. At the time of reproducing as well, crosstalk from adjacent bits is not caused. Therefore, the recording medium 20 used in the present embodiment becomes more suitable for memories having a larger capacity.

### Fifth Embodiment

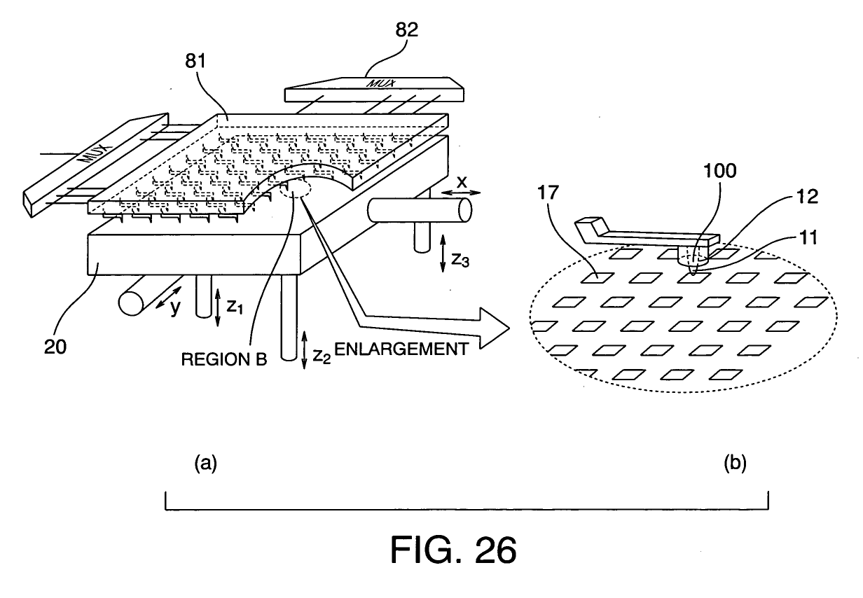

An information recording and reproducing apparatus according to a fifth embodiment of the present invention will now be described with reference to FIGS. 26(a) and 26(b). FIG. 26(a) is an oblique view for explaining a principal configuration of the information recording and reproducing apparatus according to the present embodiment. FIG. 26(b) is an enlarged view of a region B on a recording medium 20 shown in FIG. 26(a).

The information recording and reproducing apparatus according to the present embodiment includes a two-dimensional probe array 81 having a plurality of record-erase-reproduce probes 100 for the recording medium 20 or the magnetic recording medium 20 described with reference to the first to third embodiments, a multiplexer driver 82, and a record-erase-reproduce circuit (not illustrated). Each of the record-erase-reproduce probes 100 in the two-dimensional probe array 81 conducts recording, erasing and reproducing on a plurality of recording bit regions 17 included in a predetermined region (for example, a region B shown in FIG. 26(a)). Each of the record-erase-reproduce probes 100 includes a first electrode 11 and a second electrode 12. The first electrode 11 and the second electrode 12 in the present embodiment may have the same configurations as those included in the information recording and reproducing apparatus according to any of the first to third embodiments. In the present embodiment, the recording medium 20 can be moved not only in the horizontal direction (x direction and y direction), but also in the vertical direction (z₁, z₂ and z₃ directions) as shown in FIG. 26(a).

In the information and recording apparatus in the present embodiment, a plurality of record-erase-reproduce electrode needles (record-erase-reproduce probes 100) are provided, and operated in parallel. As a result, multi-channel recording, erasing and reproducing are conducted on the recording medium 20. Even if the size is reduced, therefore, it becomes possible for the information recording and recording apparatus according to the present embodiment to conduct recording, erasing and reproducing at a higher density.

According to embodiments of the present invention, a current is let flow to a minute recording portion on the recording medium by stable electron beam irradiation, as heretofore described. As a result, large-capacity fast recording, erasing and reproducing can be implemented with a practical head.

Furthermore, even under the influence of disturbance, it becomes possible to emit an electron beam obtained by field emission to a finer region on the recording portion on the recording medium stably. As a result, it is possible to implement an information recording and reproducing apparatus which is extremely high in density and high in speed by leaps and bounds as compared with the conventional art.

According to the embodiments of the present invention, therefore, it is possible to provide an information recording and reproducing apparatus which can be improved by leaps and bounds in recording density as compared with the conventional art. Industrial merits are great.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concepts as defined by the appended claims and their equivalents.

What is claimed is:

1. An information recording and reproducing apparatus comprising:
an electrode portion comprising a first electrode having an electron emission end to emit electrons by means of field emission, and a second electrode disposed around the electron emission end to control electrons being emitted from the electron emission end; and
a control portion comprising a recording-erasing circuit which causes electrons to be emitted from the electron emission end to a recording portion on a recording medium by applying a first voltage to the first electrode in a state in which a second voltage is applied to the second electrode at time of information recording or erasing, and a reproducing circuit which causes a reproducing current to flow from the electron emission end to the recording portion by applying a third voltage which is lower than the first voltage to the first electrode in a state in which the second voltage is applied to the second electrode at time of reproducing, the control portion detecting an electric resistance change caused by a change in a recording state in the recording portion.

2. The apparatus according to claim 1, wherein the second electrode is a single electrode disposed so as to surround the first electrode.

3. The apparatus according to claim 1, wherein the second electrode comprises at least two pairs of electrodes disposed so as to surround the first electrode.

4. The apparatus according to claim 1, wherein the second electrode is one pair of electrodes disposed so as to interpose the first electrode therebetween.

5. The apparatus according to claim 1, wherein
electrons are emitted in a gas atmosphere substantially having an atmospheric pressure, and
a distance from the first electrode to the recording medium is shorter than a mean free path of electrons emitted from the first electrode.

6. The apparatus according to claim 5, wherein denoting a distance from the electron emission end of the first electrode to the recording medium by d (nm), a minimum value of the mean free path of the electrons in one atmospheric pressure by λmin (nm), and a pressure in a gas atmosphere by P (Torr), a condition d<λmin×(760/P) is satisfied.

7. An information recording and reproducing apparatus comprising:
an electrode portion comprising a first electrode having an electron emission end to emit electrons by means of field emission, and a second electrode disposed around the electron emission end to control electrons emitted from the electron emission end;
a magnetic field applying portion configured to apply a magnetic field to a polarized spin control layer in a recording medium; and
a control portion comprising a recording circuit which causes the magnetic field applying portion to apply a magnetic field to the polarized spin control layer to determine a magnetization direction in the polarized spin control layer and causes electrons to be emitted from the electron emission end to make a recording current to flow to the magnetic recording layer via the polarized spin control layer by applying a first voltage to the first electrode in a state in which a second voltage is applied to the second electrode at time of information recording or erasing, and a reproducing circuit which causes the magnetic field applying portion to apply a magnetic field to the polarized spin control layer to set a magnetization direction in the polarized spin control layer and causes a reproducing current to flow from the electron emission end to the magnetic recording layer via the polarized spin control layer by applying a third voltage which is lower than the first voltage to the first electrode in a state in which the second voltage is applied to the second electrode at time of reproducing, the control portion detecting an electric resistance change caused by a change in a recording state in the magnetic recording layer as a voltage change.

8. The apparatus according to claim 7, wherein the magnetic field applying portion comprises a magnetic pole and a coil which excites the magnetic pole.

9. The apparatus according to claim 8, wherein the second electrode is the magnetic pole.

10. The apparatus according to claim 7, wherein the second electrode is a single electrode disposed so as to surround the first electrode.

11. The apparatus according to claim 7, wherein the second electrode comprises at least two pairs of electrodes disposed so as to surround the first electrode.

12. The apparatus according to claim 7, wherein the second electrode is one pair of electrodes disposed so as to interpose the first electrode therebetween.

13. The apparatus according to claim 7, wherein
electrons are emitted in a gas atmosphere substantially having an atmospheric pressure, and
a distance from the first electrode to the recording medium is shorter than a mean free path of electrons emitted from the first electrode.

14. The apparatus according to claim 13, wherein denoting a distance from the electron emission end of the first electrode to the recording medium by d (nm), a minimum value of the mean free path of the electrons in one atmospheric pressure by λmin (nm), and a pressure in a gas atmosphere by P (Torr), a condition d<λmin×(760/P) is satisfied.

15. An information recording and reproducing apparatus comprising:
an electrode portion comprising a first electrode having an electron emission end to emit electrons by means of field emission and which serves as a magnetic pole, and a second electrode disposed around the electron emission end to control electrons emitted from the electron emission end;
a magnetic field applying portion configured to apply a magnetic field to the first electrode; and
a control portion comprising a recording circuit which causes the magnetic field applying portion to apply a magnetic field to the first electrode to set a magnetization direction in the first electrode and causes spin-polarized electrons to be emitted from the electron emission end to make a recording current to flow to a magnetic recording layer in a recording medium by applying a first voltage to the first electrode in a state in which a second voltage is applied to the second electrode at time of information recording or erasing, and a reproduce circuit which lets a reproducing current flow from the electron emission end to the magnetic recording layer via the polarized spin control layer by applying a third voltage which is lower than the first voltage to the first electrode in a state in which the second voltage is applied to the second electrode at time of reproducing, the control portion detecting an electric resistance change caused by a change in a recording state in the magnetic recording layer being detected by the control portion.

16. The apparatus according to claim 15 wherein the magnetic field applying portion is a coil.

17. The apparatus according to claim 15, wherein the second electrode is a single electrode disposed so as to surround the first electrode.

18. The apparatus according to claim 15, wherein the second electrode comprises at least two pairs of electrodes disposed so as to surround the first electrode.

19. The apparatus according to claim 15, wherein the second electrode is one pair of electrodes disposed so as to interpose the first electrode therebetween.

20. The apparatus according to claim 15, wherein
electrons are emitted in a gas atmosphere substantially having an atmospheric pressure, and
a distance from the first electrode to the recording medium is shorter than a mean free path of electrons emitted from the first electrode.

21. The apparatus according to claim 20, wherein denoting a distance from the electron emission end of the first electrode to the recording medium by d (nm), a minimum value of the mean free path of the electrons in one atmospheric pressure by λmin (nm), and a pressure in a gas atmosphere by P (Torr), a condition d<λmin×(760/P) is satisfied.

22. An information recording and reproducing apparatus comprising:
a plurality of electrode portions arranged in a matrix form, each of the electrode portions comprising a first electrode having an electron emission end to emit electrons by means of field emission, and a second electrode disposed around the electron emission end to control electrons emitted from the electron emission end; and
a control portion comprising a recording-erasing circuit which causes electrons to be emitted from the electron emission end to a recording portion on a recording medium by applying a first voltage to the first electrode in a state in which a second voltage is applied to the second electrode at time of information recording or erasing, and a reproducing circuit which causes a reproducing current to flow from the electron emission end to the recording portion on the recording medium by applying a third voltage which is lower than the first voltage to the first electrode in a state in which the second voltage is applied to the second electrode at time of reproducing, the control portion detecting an electric resistance change caused by a change in a recording state in the recording portion,
first electrodes respectively in the electrode portions being operated in parallel to conduct multi-channel recording, erasing or reproducing simultaneously on the recording medium.

23. An information recording and reproducing apparatus comprising:
a plurality of electrode portions arranged in a matrix form, each of the electrode portions comprising a first electrode having an electron emission end to emit electrons by means of field emission, and a second electrode disposed around the electron emission end to control electrons emitted from the electron emission end;
magnetic field applying portions provided to correspond to the plurality of electrode portions and configured to apply a magnetic field to a polarized spin control layer in a recording medium; and
a control portion comprising a recording circuit which causes the magnetic field applying portion to apply a magnetic field to the polarized spin control layer to determine a magnetization direction in the polarized spin control layer and causes electrons to be emitted from the electron emission end to make a recording current to flow to the magnetic recording layer via the polarized spin control layer by applying a first voltage to the first electrode in a state in which a second voltage is applied to the second electrode at time of information recording or erasing, and a reproducing circuit which causes the magnetic field applying portion to apply a magnetic field to the polarized spin control layer to set a magnetization direction in the polarized spin control layer and causes a reproducing current to flow from the electron emission end to the magnetic recording layer via the polarized spin control layer by applying a third voltage which is lower than the first voltage to the first electrode in a state in which the second voltage is applied to the second electrode at time of reproducing, the control portion detecting an electric resistance change caused by a change in a recording state in the magnetic recording layer as a voltage change,
first electrodes respectively in the electrode portions being operated in parallel to conduct multi-channel recording, erasing or reproducing simultaneously on the recording medium.
